(19) United States
(12) Patent Application Publication
(10) Pub. No.: US 2007/0050569 A1
(43) Pub. Date: Mar. 1, 2007

(54) Data management system and method

(76) Inventors: Nils Haustein, Zornheim (DE); Craig A. Klein, Tucson, AZ (US); Daniel J. Winarski, Tucson, AZ (US)

Correspondence Address: DALE F. REGELMAN, 4231 S. FREMONT AVENUE, TUCSON, AZ, 85714, US

(21) Appl. No.: 11/219,424

(22) Filed: Sep. 1, 2005

(51) Int. Cl. G06F 13/00

(52) U.S. Cl. 711/154

(57) ABSTRACT

A data management method is disclosed. The method provides a plurality of data storage media, where each data storage media comprises one of (M) media types. The method establishes, for each of the (M) media types, a Media Quality Threshold, an Access Threshold, an Age Threshold, and an Environmental Threshold. The method optionally also establishes a Data Management Policy for each of the (M) media types. In examining the (i)th data storage medium, if none of the applicable Thresholds are exceeded, and if the Data Management Policy does not require data refreshing, then the (i)th data storage medium is returned to storage. If the Data Management Policy requires data refreshing, then the method reads the information encoded on the (i)th data storage medium and writes that information to the (i)th data storage medium. If the (i)th medium quality is less than the (j)th Medium Quality Threshold, or if any of the other applicable Thresholds are exceeded, then the method copies the information encoded on the (i)th data storage medium to a new data storage medium.

### FIELD OF THE INVENTION

The invention is related in general to data archiving and data management. More particularly, the invention comprises one or more of data copying, data refreshing, and media selection, depending on the length of time data is archived and retained.

### BACKGROUND OF THE INVENTION

Data archiving typically requires retaining data for specific period of time. This specific time period is sometimes referred to as the retention time. The retention time can be regulated by governments for certain types of data. For example, financial records need to be kept for a minimum of ten years in Germany, and documents associated with accounts must be kept for five years. Other retention times for data archiving may range from one to thirty years for certain types of data.

Regulations require the archiving data to be readable at any point of time during retention. Problems can arise when data must be stored for lengthy retention times. The data storage media comprising the archived data may deteriorate over time. For example, the frontcoat of magnetic tape may degrade with age due to oxidation and crosslinking. The frontcoat could then become brittle, and chemically break-down which would allow the data-bearing magnetic particles to literally fall off of the tape. Additionally, the read characteristic of storage media may become more error prone over time. As an example, the magnetic particles in magnetic tape may oxidize, and that loss of magnetization results in permanent data loss.

In hard disk drives, magnetic domains might migrate via the effect of vibration, which could blur the transitions between ones and zeros. If a hard disk is not run periodically, the lubricant of that hard disk may migrate to the hub of the disk due to capillary action. This would mean that there would be no lubricant at the outer edge of the data area and a head crash would cause data loss.

Even if the storage medium remains viable, an application may no longer exist to read the data encoded on that medium. Historical software may no longer be supported or upgraded to run on new operating systems. Although data written using such historical software remains, that data is functionally useless.

Obsolescence of storage technology creates yet another problem attendant to data archiving. Storage technology comprises a useful lifetime, after which that technology becomes obsolete. Such an obsolete storage technology may not longer be supported by computer systems and/or applications, and therefore, the data written using that obsolete technology may no longer be useable.

What is needed is a data management method that determines the physical quality of each data storage medium disposed in the system, and further examines the access frequency of each data storage medium, the age of each data storage medium, and the environmental parameters related to the storage of each data storage medium.

### SUMMARY OF THE INVENTION

Applicants' invention comprises a data management method. The method provides a plurality of data storage media comprising information, where each data storage media comprises one of (M) media types, where (M) is greater than or equal to 1. The storage media type may comprise different media types within one storage technology, for example for tape this might be LTO-1, LTO-2 and LTO-3. It may also comprise the media type of different storage technologies such as Tape, Optical and Disk.

The method establishes, for each of the (M) media types a Media Quality Threshold, an Access Threshold, an Age Threshold, and an Environmental Threshold. The method optionally also establishes a Data Management Policy for each of the (M) media types.

The method selects the (i)th data storage medium, where that (i)th data storage medium is one of the plurality of data storage media, and where that (i)th data storage medium comprises the (j)th media type, where the (j)th media type is one of the (M) media types. The method determines the (i)th medium quality, and ascertains if the (i)th medium quality is greater than the (j)th Media Quality Threshold. If the (i)th medium quality is not less than the (j)th Media Quality Threshold, then the method determines the (i)th access parameters, the (i)th age parameters, the (i)th environmental parameters, and compares those parameters to the (j)th Access Threshold, the (j)th Age Threshold, and the (j)th Environmental Threshold, respectively.

If none of the applicable Thresholds are exceeded, and if the Data Management Policy does not require data refreshing, then the examination of the (i)th data storage medium ends. If none of the applicable Thresholds are exceeded, but the Data Management Policy requires data refreshing, then the method reads the information encoded on the (i)th data storage medium and writes that information to the (i)th data storage medium.

If the (i)th medium quality is less than the (j)th Medium Quality Threshold, or if any of the other applicable Thresholds are exceeded, then the method supplies a new data storage medium, and copies the information encoded on the (i)th data storage medium to the new data storage medium. The new data storage medium may be of the same, or differing, media type as the (i)th data storage medium.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram illustrating aspects of Applicants' storage area network (“SAN”);

FIG. 2 is a block diagram showing one embodiment of Applicants' retention management system including a left hand service bay, multiple storage frames, and a right hand service bay;

FIG. 3 is block diagram showing certain components of the retention management system of FIG. 2;

FIG. 4A is a perspective view of the front of a data storage drive mounted in a drive canister;

FIG. 4B is a perspective view of the rear of the apparatus of FIG. 4A;

FIG. 5 is perspective view of a tape cartridge comprising cartridge memory;

FIG. 6 is a perspective view of a reel of tape contained in the tape cartridge of FIG. 5;

FIG. 7 is a block diagram showing the internal structure of Applicants' document management system;

FIG. 8A is a flowchart summarizing the steps of Applicants' copy process;

FIG. 8B is a continuation of FIG. 8A;

FIG. 9 is a flowchart summarizing the steps to determine the appropriate storage medium based upon retention time and access time requirements;

FIG. 10 is a flow chart summarizing the initial steps in Applicants' method;

FIG. 11A is a flow chart summarizing additional steps in Applicants' method;

FIG. 11B is a continuation of FIG. 11A;

FIG. 12A is a flow chart summarizing additional steps in Applicants' method;

FIG. 12B is a continuation of FIG. 12A; and

FIG. 13 is a flow chart summarizing additional steps in Applicants' method.

### DETAILED DESCRIPTION OF THE PREFERRED EMBODIMENTS

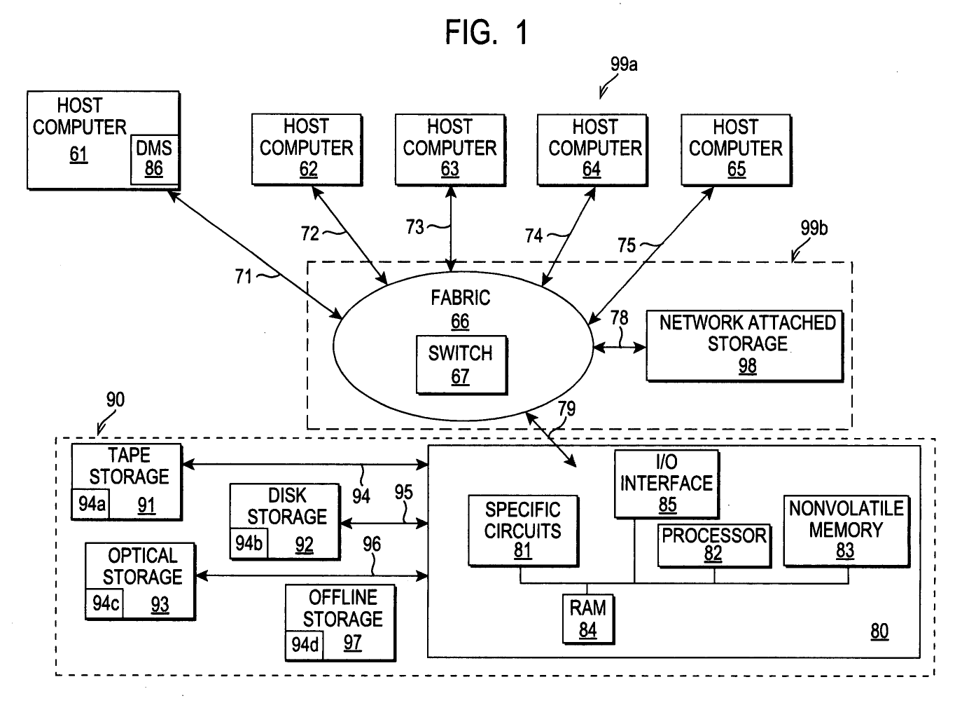

Referring to figures, wherein like parts are designated with the same reference numerals and symbols. FIG. 1 is a block diagram that illustrates one embodiment of Applicants' data management system 99a which comprises storage area network (“SAN”) 99b. In the illustrated embodiment of FIG. 1, SAN 99b comprises Network Attached Storage (“NAS”) 98 and a switched-access-network, wherein switches 67 are used to create a switching fabric 66. In this embodiment of the invention, SAN 99b is implemented using Small Computer Systems Interface (SCSI) protocol running over a Fibre Channel (“FC”) physical layer. In other embodiments, SAN 99b utilizes other protocols, such as without limitation Infiniband, FICON, TCP/IP, Ethernet, Gigabit Ethernet, or iSCSI. The switches 67 have the addresses of both the hosts 61, 62, 63, 64, 65, controller 80, and Network Attached Storage (NAS) 98.

Host computers 61, 62, 63, 64, 65 are connected to the fabric 66 utilizing I/O interfaces 71, 72, 73, 74, 75 respectively. In the illustrated embodiment of FIG. 1, host computer 61 comprises Document Management System (“DMS”) 86. In other embodiments, retention management system 90 comprises DMS 86.

Among other things, DMS 86 indexes the information and data storage media disposed in retention management system 90. Document Management System 86 associates the information/document with the data storage medium encoded with that information/document. Based on these DMS indices, searches may be made for information/documents stored in the retention management system.

I/O interfaces 71-75 may be any type of I/O interface; for example, a FC arbitrated loop, a direct attachment to fabric 66 or one or more signal lines used by host computers 61-65 to transfer information respectfully to and from fabric 66. Fabric 66 includes, for example, one or more FC switches 67 used to connect two or more computer networks.

Switch 67 interconnects host computers 61-65 to controller 80 across I/O interface 79. I/O interface is used to transfer information respectfully to and from controller 80 and subsequently tape storage 91, disk storage 92, and optical storage 93. I/O interface 79 comprises any one or more types of known interface, for example, a Fibre Channel, Infiniband, Gigabit Ethernet, Ethernet, TCP/IP, iSCSI, SCSI I/O interface or one or more signal lines used by FC switch 67.

In the illustrated embodiment of FIG. 1, Retention Management System 90 comprises controller 80, tape storage 91, disk storage 92, optical storage 93, and offline storage 97, where removable media from tape storage 91, disk storage 92, and optical storage 93 may be shelved for long periods of time in an “offline” state.

Each of tape storage 91, disk storage 92, optical storage 93, and offline storage 97, comprise an environmental sensing device 94. Environmental sensing devices 94a, 94b, 94c, and 94d, continuously monitor and log the temperature and relative humidity within tape storage 91, disk storage 92, optical storage 93, and offline storage 97, respectively. The environmental sensing device may also sense other environmental parameters such as the air pollution, particle density and chemical contents of the air. In certain embodiments, the temperature and/or humidity data sensed by each environmental sensing device 94 are written to a data storage medium disposed therein. In other embodiments, the temperature and/or humidity data sensed by each environmental sensing device 94a, 94b, and 94c, are provided to controller 80 via communication links 94, 95, and 96, respectively.

In certain embodiments, controller 80 writes the environmental sense data provided by devices 94a, 94b, and 94c, to Document Management System (“DMS”) 86. In certain embodiments, DMS 86 determines the environmental data for each of the (N) data storage media, and updates the temperature and relative humidity levels to which the (i)th data storage medium was exposed, wherein (i) is greater than or equal to 1 and less than or equal to (N).

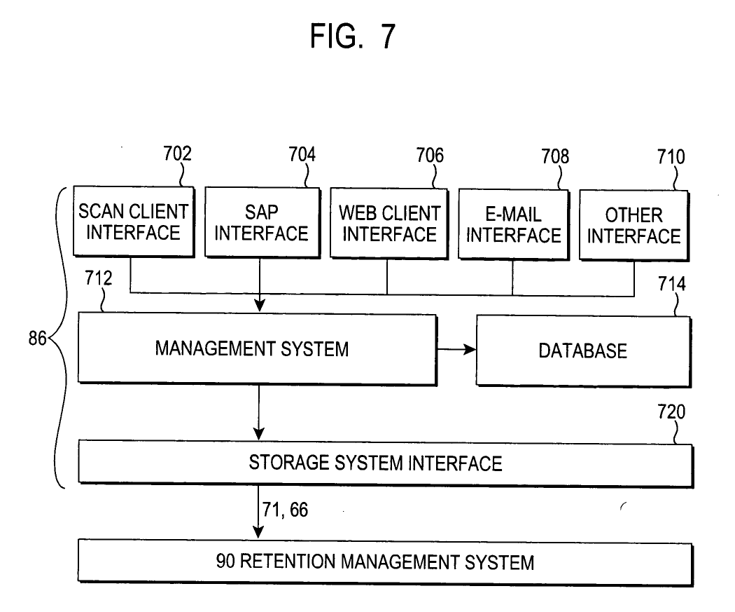

In certain embodiments, controller 80 writes the environmental sense data provided by devices 94a, 94b, and 94c, to database 714 (FIG. 7) disposed in Document Management System 86.

Retention Management System 90 comprises one or more controllers 80 which implement Applicants' data management method. In certain embodiments, controller 80 comprises an embedded system. In certain embodiments, controller 80 comprises a distributed control system. In certain embodiments, controller 80 comprises a personal computer. In certain embodiments, controller 80 comprises a workstation. In the illustrated embodiment of FIG. 1, controller 80 comprises processor 82, random access memory (“RAM”) 84, nonvolatile memory 83, specific circuits 81, and an I/O interface 85. In other embodiments, controller 80 is implemented entirely in software in one of hosts 61-65.

In certain embodiments, processor 82 comprises an off-the-shelf microprocessor. In certain embodiments, processor 82 comprises a custom processor. In certain embodiments, processor 82 comprises a FPGA. In certain embodiments, processor 82 comprises an ASIC. In certain embodiments, processor 82 comprises another form of discrete logic. RAM 84 is used to cache data being written by hosts 61-65 or being read for hosts 61-65, or hold calculated data, stack data, executable instructions, etc. Nonvolatile memory 83 may comprise any type of nonvolatile memory such as Electrically Erasable Programmable Read Only Memory (“EEPROM”), flash Programmable Read Only Memory (“PROM”), battery backup RAM, hard disk drive, or other similar device.

Nonvolatile memory 83 is used to hold the executable firmware and any nonvolatile data. I/O interface 85 comprises one or more communication interfaces which allow processor 82 to communicate with tape storage 91, disk storage 92, and optical storage 93, as well as Fabric 66. Examples of I/O interface 85 include serial interfaces such as RS-232, USB (Universal Serial Bus), SCSI (Small Computer Systems Interface), Fibre Channel, or Gigabit Ethernet, etc. In addition, I/O interface 85 may comprise a wireless interface such as radio frequency (“RF”) or Infrared.

The specific circuits 81 provide additional hardware to enable the controller 80 to perform unique functions, such as fan control for the environmental cooling of controller 80. Specific circuits 81 may comprise electronics that provide Pulse Width Modulation (PWM) control, Analog to Digital Conversion (ADC), Digital to Analog Conversion (DAC), etc. In addition, all or part of the specific circuits 81 may reside outside controller 80.

In certain embodiments, RAM 84 and/or nonvolatile memory 83 is disposed in processor 82. In certain embodiments, specific circuits 81 and/or I/O interface 85 is disposed within processor 82.

Switch 67 interconnects host computers 61-65 to Network Attached Storage 98 across I/O interface 78. I/O interface 78 may be any type of I/O interface, for example, a Fibre Channel, Infiniband, Gigabit Ethernet, TCP/IP, iSCSI, SCSI I/O interface, or one or more signal lines used by FC switch 67 to transfer information respectfully to and from Network Attached Storage 98. Network Attached Storage 98 may comprise tape storage, disk storage, or optical storage.

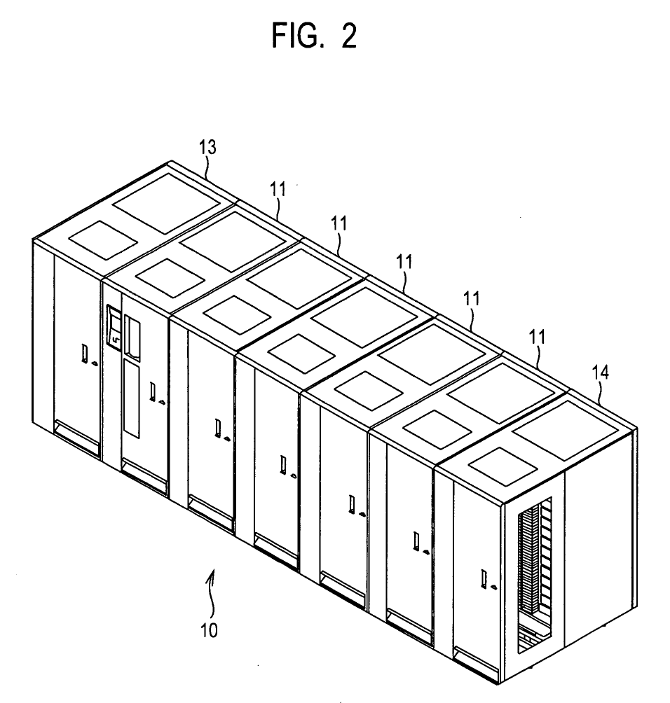

FIG. 2 shows automated data storage library 10. An example of an automated data storage library which may be implemented in the present invention is the IBM 3584 UltraScalable Tape Library®. In certain embodiments, library 10 comprises tape storage 91 (FIG. 1). In certain embodiments, library 10 comprises disk storage 92 (FIG. 1). In certain embodiments, library 10 comprises optical storage 93 (FIG. 1).

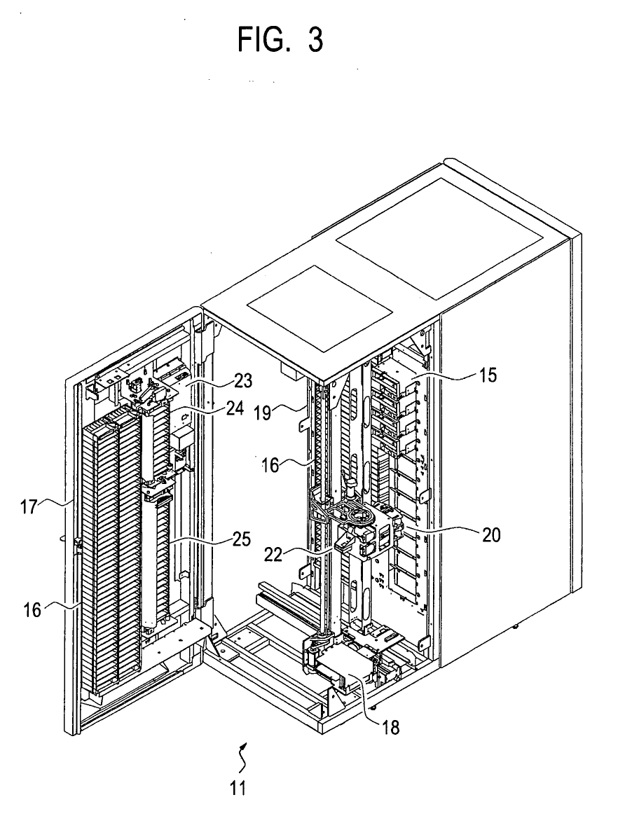

In the illustrated embodiment of FIG. 2, automated data storage library 10 comprises left hand service bay 13, a plurality of storage frames 11, and right hand service bay 14. Frames 11 may be added or removed to expand or reduce the size and/or functionality of library 10. FIG. 3 shows one embodiment of storage frame 11.

In the illustrated embodiment of FIG. 3, frame 11 comprises a plurality of storage shelves 16 disposed on front wall 17 and rear wall 19, at least one data storage drive 15, and at least one accessor 18. Accessor 18 is capable of removing a portable data storage medium from a storage shelf 16, transporting that data storage medium to drive 15, and mounting that data storage medium in data storage drive 15. In certain embodiments, the portable data storage medium is disposed in a portable housing, i.e. a cassette or cartridge.

Accessor 18 comprises a gripper assembly 20 for gripping one or more data storage media. In certain embodiments, accessor 18 further comprises a bar code scanner 22 or reading system, such as a smart card reader or similar system, mounted on the gripper 20.

Storage frame 11 optionally comprises operator panel 23, or other user interface, such as a web-based interface, which allows a user to interact with the library. In addition, storage frame 11 optionally comprises an upper I/O station 24 or a lower I/O station 25, which allows data storage media to be inserted into the library and/or removed from the library without disrupting library operation.

In certain embodiments, the (N) data storage media moveably disposed within automated library 10 comprise one of (M) media types, where those (M) media types comprise, without limitation, as tape, optical or disk. Library 10 further comprises one or more data drives for each of those (M) media types.

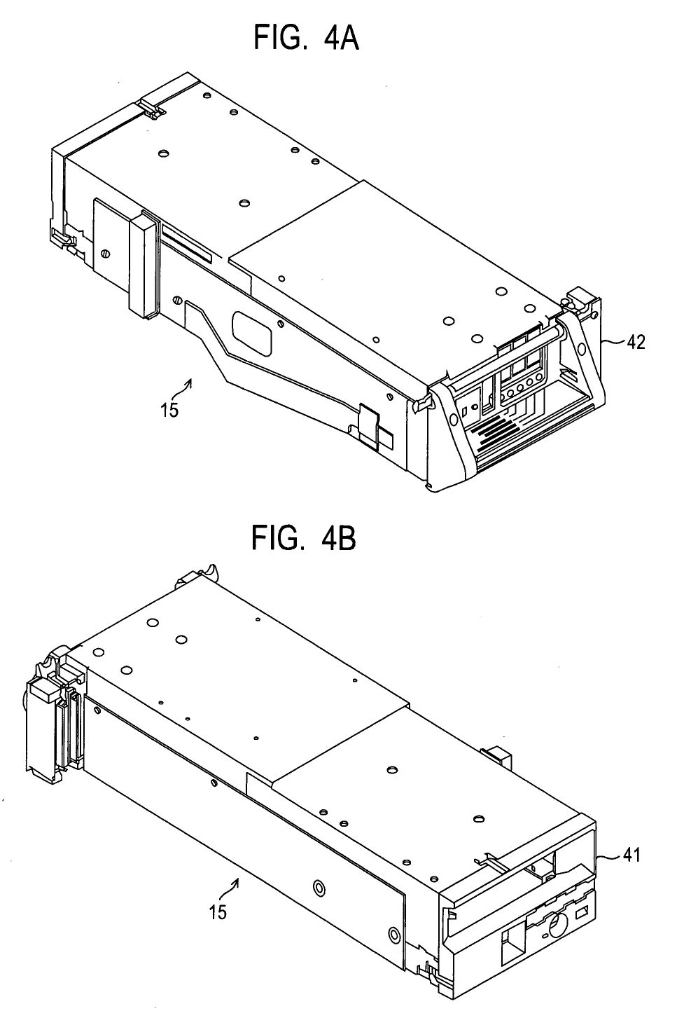

FIGS. 4A and 4B show drive 15. In the illustrated embodiments of FIGS. 4A and 4B, drive 15 comprises a removable media LTO (Linear Tape Open) tape drive mounted in a drive canister and disposed in a portion of tape storage 91 (FIG. 1). In certain embodiments, tape storage 91 comprises a plurality of tape drives. FIG. 4A shows front of drive 41 and FIG. 4B shows rear of drive 42.

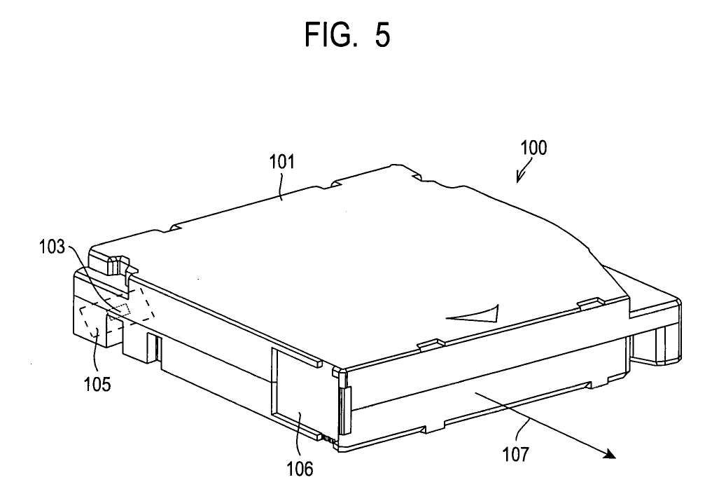

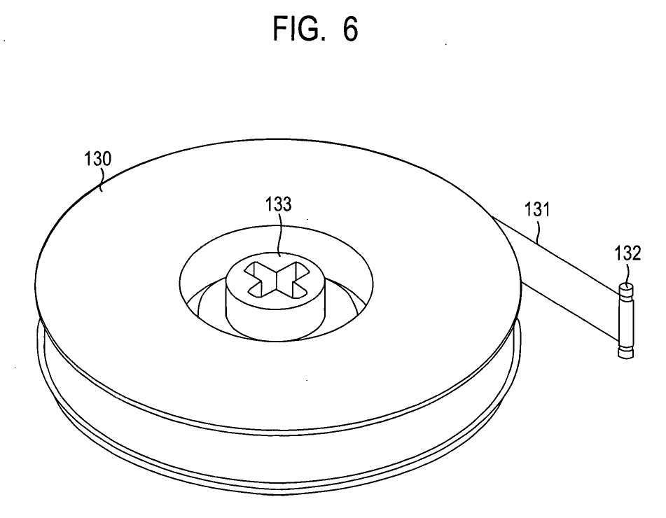

FIG. 5 shows exemplary tape cartridge 100. Tape cartridge 100 comprises exterior cartridge shell 101 and sliding door 106. Sliding door 106 is slid open when tape cartridge 100 is inserted into an appropriate tape drive 15. Sliding door 106 is normally closed when tape cartridge 100 is not in use, so that debris and contaminants do not enter tape cartridge 100 and degrade tape 131 (FIG. 6).

In certain embodiments, tape cartridge 100 further comprises cartridge memory 103. In certain embodiments, cartridge memory 103 is disposed on printed circuit board 105. Cartridge memory 103 is disposed at about a forty-five degree angle, to allow drive 15 and accessor 18 to wirelessly access the contents of cartridge memory 103. Tape cartridge 100 is loaded into drive 15 along direction 107.

FIG. 6 shows exemplary tape reel 130, which is stored in tape cartridge 100. Tape reel 130 is prevented from rotation when tape cartridge 100 is not in drive 15 by brake button 133. Drive 15 releases brake button 133 when tape cartridge 100 is inserted into drive 15, which then allows the free rotation of tape reel 130. Tape reel 130 is wound with tape 131.

Leader pin 132 is disposed on the one end of tape 131. When tape cartridge 100 is mounted in drive 15, sliding door 106 is opened, and tape drive 15 threads leader pin 132 and attached tape 131 through the tape path.

Tape 131 comprises a substrate and one or more frontcoats. The frontcoat comprises particles which hold the data, and a binder which binds the particles to the substrate. In certain embodiments, these particles comprise chromium dioxide (CrO₂) particles or metal particles. In certain embodiments, the metal particles comprise oxide-coated iron metal or magnetic ferrites such as barium ferrite. In other embodiments, tape 131 comprises a magneto-optical or optical phase-change medium.

The contents of cartridge memory 103 are used to identify the volume serial number (“VOLSER”) of tape cartridge 100, and may comprise a directory of the contents encoded on tape 103.

In certain embodiments, disk storage 92 comprises one or more hard disk drives, wherein each such disk drive is disposed within a portable cassette. In certain embodiments, such a portable hard disk drive cassette comprises a geometry substantially identical to tape cartridge 100. U.S. Pat. No. 6,545,865 teaches such a hard disk drive disposed in a portable cassette, and is herein incorporated by reference.

Optical storage 93 may comprise disks comprising a magneto-optical storage medium, phase-change storage medium, DVD-ROM storage medium, DVD-RAM storage medium, DVD+/−R storage medium, DVD+/−RW storage medium, HD-DVD (High Definition DVD) storage medium, Blu-Ray storage medium, and/or holographic storage medium. In certain embodiments, such optical disk media are disposed in a portable cassette.

In certain embodiments, Applicants' data management system 99a comprises a document management system (“DMS”). In the illustrated embodiment of FIG. 1, DMS 86 is disposed in host computer 61. In other embodiments, DMS 86 is disposed in retention management system 90. Referring now to FIG. 7, DMS 86 comprises interfaces, sometimes also called connectors, to different client systems 702, 704, 706, 708, and 710. In the illustrated embodiment of FIG. 7, interface 702 comprises an integrated scan apparatus which is used to scan documents, such as for example invoices. The content of the scanned documents, and the associated meta data, is provided to the management system 712. In certain embodiments, the meta data comprises the type of document, date and time, and also some of the content which can be made available in digital text form through a coupled OCR (optical character recognition) system.

The meta data facilitates searches and easy management of the document. For example, in the case of invoices the meta data may contain account numbers, order numbers and names. In certain embodiments, the actual content of the data comprises the copy of the invoice. Management system 712 stores the name of the invoice, the storage location and the meta data in database 714, and the content of the object in the retention management system via the storage system interface 720.

The storage location stored in the data base system 714 refers to the retention management system. The storage system interface 720 incorporates the logic enabling the communication between management system 712 and retention management system 90. This logic comprises functions to transfer the retention time, the access requirement, and other retention management parameters for an object to the retention management system. The retention management system 90 (FIG. 1) is connected via a link 71 (FIG. 1), a fabric 66 (FIG. 1), comprising one or more switches 67 (FIG. 1), and a link 79 (FIG. 1) to controller 80 (FIG. 1) disposed in Applicants' retention management system 90.

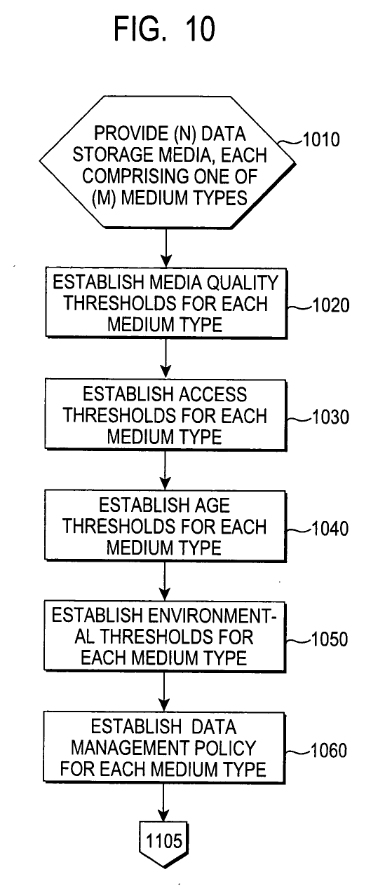

Applicants' invention includes a data management method. FIG. 10 summarizes the initial steps in Applicants' method. Referring now to FIG. 10, in step 1010 Applicants' method provides a retention management system, such as for system 90 (FIG. 1), wherein that system comprises (N) data storage media, wherein each of those (N) data storage media comprise one of (M) media types. In certain embodiments, these (M) media types comprise zero or more magnetic storage media types, zero or more optical storage media types, zero or more electronic storage media, combinations thereof, and the like. In certain embodiments, Applicants' magnetic storage media comprise hard disks, magnetic tapes, RAID arrays, combinations thereof, and the like.

In certain embodiments, Applicants' optical storage media comprise, without limitation, magneto-optical, phase-change, CD-ROM, DVD-ROM, DVD-RAM (Random Access Memory), CD+/−R, DVD+/−R (Write Once), CD+/−RW, DVD+/−RW, HD-DVD, Blu-Ray, holography, combinations thereof, and the like. In certain embodiments, Applicants' electronic storage media comprise, without limitation, one or more, PROMs, EPROMs, EEPROMs, Flash PROMs, compactflash, smartmedia, and the like

In step 1020, Applicants' method establishes a Media Quality Threshold for each of the (M) media types. In certain embodiments, the one or more Media Quality Thresholds are stored in document management system (“DMS”) 86. In certain embodiments, the one or more Media Quality Thresholds are stored in database 714 disposed in DMS 86.

As a general matter, the (j)th Media Quality Threshold is associated with the (j)th media type, wherein (j) is greater than or equal to 1, and less than or equal to (M). In certain embodiments, step 1020 includes establishing a different Media Quality Threshold for each of Applicants' various magnetic data storage media types, a different Media Quality Threshold for each of Applicants' optical data storage media types, and a different Media Quality Threshold for each of Applicants' electronic data storage media types.

As an example, if Applicants' retention management system comprises CD-ROM, DVD-ROM, DVD-RAM, CD+/−R, DVD+/−R, CD+/−RW, and DVD+/−RW, data storage media types, then (M) is 7, and step 1020 comprises establishing up to 7 different Media Quality Thresholds.

As a further example, if Applicants' retention management system comprises one or more magnetic tapes formatted to be removeably disposed in a first tape drive unit type, one or more magnetic tapes formatted to be removeably disposed in a second tape drive unit type, and one or more magnetic tapes formatted to be removeably disposed in a third tape drive unit type, then step 1020 comprises establishing up to 3 different Media Quality Thresholds.

In certain embodiments, one or more of the Media Quality Thresholds of step 1020 are provided by the manufacturers of the respective data storage media. In certain embodiments, one or more of the Media Quality Thresholds of step 1020 are established by the owner/operator of the retention management system comprising the data storage media. In certain embodiments, one or more of the Media Quality Threshold of step 1020 are provided by one or more host computers in communication with the retention management system comprising the data storage media. In certain embodiments, one or more of the Media Quality Thresholds of step 1020 are provided by one or more customers under a Service Level Agreement entered into by and between a data storage services customer and a data storage services provided.

In step 1030, Applicants' method establishes Access Thresholds for each medium type disposed in Applicants' retention management system. In certain embodiments, the one or more Access Thresholds are stored in document management system (“DMS”) 86. In certain embodiments, the one or more Access Thresholds are stored in database 714 disposed in DMS 86.

In certain embodiments, Applicants' Access Threshold comprises an access frequency component, such as for example the average time interval between operations wherein information is either written to, or read from, a data storage medium. In certain embodiments, Applicants' Access Threshold comprises a total number of accesses component, such as for example the number of times information is either written to, or read from, a data storage medium within a designated time interval. In certain embodiments, the designated time interval comprises one year. In certain embodiments, Applicants' Access Threshold comprises an access frequency component and a total number of accesses component.

In step 1030, Applicants' method establishes an Access Threshold for each of the (M) media types. As a general matter, the (j)th Access Threshold is associated with the (j)th media type, wherein (j) is greater than or equal to 1, and less than or equal to (M). In certain embodiments, step 1030 includes establishing a different Access Threshold for each of Applicants' various magnetic data storage media types, a different Access Threshold for each of Applicants' optical data storage media types, and a different Access Threshold for each of Applicants' electronic data storage media types.

As an example, if Applicants' retention management system comprises CD-ROM, DVD-ROM, DVD-RAM, CD+/−R, DVD+/−R, CD+/−RW, and DVD+/−RW, data storage media types, then (M) is 7, and step 1030 comprises establishing up to 7 different Access Thresholds.

As a further example, if Applicants' retention management system comprises one or more magnetic tapes formatted to be removeably disposed in a first tape drive unit type, one or more magnetic tapes formatted to be removeably disposed in a second tape drive unit type, and one or more magnetic tapes formatted to be removeably disposed in a third tape drive unit type, then step 1030 comprises establishing up to 3 different Access Thresholds.

In certain embodiments, one or more of the Access Threshold of step 1020 are provided by the manufacturers of the respective data storage media. In certain embodiments, one or more of the Media Quality Thresholds of step 1030 are established by the owner/operator of the retention management system comprising the data storage media. In certain embodiments, one or more of the Access Thresholds of step 1030 are provided by one or more host computers in communication with the retention management system comprising the data storage media. In certain embodiments, one or more of the Access Thresholds of step 1030 are provided under a Service Level Agreement entered into by and between a data storage services customer and a data storage services provider.

In step 1040, Applicants' method establishes an Age Threshold for each of the (M) media types. In certain embodiments, the one or more Age Thresholds are stored in document management system (“DMS”) 86. In certain embodiments, the one or more Age Thresholds are stored in database 714 disposed in DMS 86. In certain embodiments, the one or more Age Thresholds comprise the age of the storage medium. In certain embodiments, the age of the storage medium comprises the time interval between the current date and the date the data storage medium was entered into the retention management system 90. In certain embodiments, the age of the storage medium is based on the date of manufacture.

As a general matter, the (j)th Age Threshold is associated with the (j)th media type, wherein (j) is greater than or equal to 1, and less than or equal to (M). In certain embodiments, step 1040 includes establishing a different Age Threshold for each of Applicants' various magnetic data storage media types, a different Age Threshold for each of Applicants' optical data storage media types, and a different Age Threshold for each of Applicants' electronic data storage media types.

As an example, if Applicants' retention management system comprises CD-ROM, DVD-ROM, DVD-RAM, CD+/−R, DVD+/−R, CD+/−RW, and DVD+/−RW, data storage media types, then (M) is 7, and step 1040 comprises establishing up to 7 different Age Thresholds.

As a further example, if Applicants' retention management system comprises one or more magnetic tapes formatted to be removeably disposed in a first tape drive unit type, one or more magnetic tapes formatted to be removeably disposed in a second tape drive unit type, and one or more magnetic tapes formatted to be removeably disposed in a third tape drive unit type, then step 1040 comprises establishing up to 3 different Age Thresholds.

In certain embodiments, one or more of the Age Thresholds of step 1040 are provided by the manufacturers of the respective data storage media. In certain embodiments, one or more of the Age Thresholds of step 1040 are established by the owner/operator of the retention management system comprising the data storage media. In certain embodiments, one or more of the Age Thresholds of step 1040 are provided by one or more host computers in communication with the retention management system comprising the data storage media. In certain embodiments, one or more of the Age Thresholds of step 1040 are provided under a Service Level Agreement entered into by and between a data storage services customer and a data storage services provider.

In step 1050, Applicants' method establishes an Environmental Threshold for each of the (M) media types. In certain embodiments, the one or more Environmental Thresholds are stored in document management system (“DMS”) 86. In certain embodiments, the one or more Environmental Thresholds are stored in database 714 disposed in DMS 86.

In certain embodiments, Applicants' Environmental Threshold comprises a temperature component. The rate, k, of degradation of certain data storage media follows the Arrhenius rate equation (1):
k=Z*10^{-Ea/RT} (1)
In certain embodiments, Applicants' Environmental Threshold comprises the maximum acceptable average storage temperature. In certain embodiments, Applicants' Environmental Threshold comprises the maximum acceptable short term storage temperature. In certain embodiments, the “short term” time interval is set to 24 hours. In certain embodiments, Applicants' Environmental Threshold comprises maximum acceptable average storage temperature and a maximum acceptable short term storage temperature.

For certain data storage media, log k is further a finction of the square of the relative humidity as recited in equation (2):
Log k=A[RH]²+B (2)
In certain embodiments, Applicants' Environmental Threshold comprises the maximum acceptable average storage relative humidity component. In certain embodiments, Applicants' Environmental Threshold comprises the maximum acceptable short term storage relative humidity component, wherein “short term” is defined hereinabove. In certain embodiments, Applicants' Environmental Threshold comprises maximum acceptable average storage relative humidity and a maximum acceptable short term storage relative humidity.

As a general matter, the (j)th Environmental Threshold is associated with the (j)th media type, wherein (j) is greater than or equal to 1, and less than or equal to (M). In certain embodiments, step 1050 includes establishing a different Environmental Threshold for each of Applicants' various magnetic data storage media types, a different Environmental Threshold for each of Applicants' optical data storage media types, and a different Environmental Threshold for each of Applicants' electronic data storage media types.

As an example, if Applicants' retention management system comprises CD-ROM, DVD-ROM, DVD-RAM, CD+/−R, DVD+/−R, CD+/−RW, and DVD+/−RW, data storage media types, then (M) is 7, and step 1050 comprises establishing up to 7 different Environmental Thresholds.

As a further example, if Applicants' retention management system comprises one or more magnetic tapes formatted to be removeably disposed in a first tape drive unit type, one or more magnetic tapes formatted to be removeably disposed in a second tape drive unit type, and one or more magnetic tapes formatted to be removeably disposed in a third tape drive unit type, then step 1050 comprises establishing up to 3 different Environmental Thresholds.

In certain embodiments, one or more of the Environmental Thresholds of step 1050 are provided by the manufacturers of the respective data storage media. In certain embodiments, one or more of the Environmental Thresholds of step 1050 are established by the owner/operator of the retention management system comprising the data storage media. In certain embodiments, one or more of the Environmental Thresholds of step 1050 are provided by one or more host computers in communication with the retention management system comprising the data storage media. In certain embodiments, one or more of the Environmental Thresholds of step 1050 are provided under a Service Level Agreement entered into by and between a data storage services customer and a data storage services provider.

In step 1060, Applicants' method establishes a Data Management Policy. In certain embodiments, the Data Management Policy is stored in document management system (“DMS”) 86. In certain embodiments, the Data Management Policy is stored in database 714 disposed in DMS 86.

In certain embodiments, the Data Management Policy of step 1060 comprises policies directed to migrating information from a first data storage medium type, i.e. magnetic tape for example, to a second data storage medium type, i.e. an optical data storage medium. For purposes of this Application, “data migration” comprises copying the data encoded on a first data storage medium type to a second data storage medium type.

For purposes of this Application, “copying data”, and/or “copies data” means using any process to read all or a portion of the data encoded on a first data storage medium, and then write that data to all or a portion of a second data storage medium, wherein the first data storage medium type may be the same as, or differ from, the second data storage medium type. Such copy processes include, without limitation, FlashCopy, XRC (Extended Remote Copy), PPRC (Peer to Peer Remote Copy), and the like.

The Data Management Policy further comprises policies for retention of storage medium with in the Data Retention System 90. The Data Management Policy further comprises policies for format conversion.

In certain embodiments, the Data Management Policy of step 1060 comprises one or more Refresh Policies. For purposes of this Application, “data refreshing” comprises reading data from a designated data storage medium, and writing that data to that same designated data storage medium. In certain embodiments, such data refreshing comprises reading data from a first location of the designated data storage medium, and then writing that data to a second location of the designated data storage medium. In certain embodiments, data refreshing comprises reading and storing data from a designated data storage medium, erasing that data storage medium, and then writing the stored data to the newly-erased, designated data storage medium.

In certain embodiments, step 1060 further comprises establishing a Refresh Policy for each of the (M) media types. As a general matter, the (j)th Refresh Policy is associated with the (j)th media type, wherein (j) is greater than or equal to 1, and less than or equal to (M). In certain embodiments, step 1060 includes establishing a different Refresh Policy for each of Applicants' various magnetic data storage media types, a different Refresh Policy for each of Applicants' optical data storage media types, and a different Refresh Policy for each of Applicants' electronic data storage media types.

As an example, if Applicants' retention management system comprises CD-ROM, DVD-ROM, DVD-RAM, CD+/−R, DVD+/−R, CD+/−RW, and DVD+/−RW, data storage media types, then (M) is 7, and step 1060 comprises establishing up to 7 different Refresh Policies.

As a further example, if Applicants' retention management system comprises one or more magnetic tapes formatted to be removeably disposed in a first tape drive unit type, one or more magnetic tapes formatted to be removeably disposed in a second tape drive unit type, and one or more magnetic tapes formatted to be removeably disposed in a third tape drive unit type, then step 1060 comprises establishing up to 3 different Refresh Policies.

In certain embodiments, one or more of the Refresh Policies of step 1060 are established by the owner/operator of the retention management system comprising the data storage media. In certain embodiments, one or more of the Refresh Policies of step 1060 are provided by one or more host computers in communication with the retention management system comprising the data storage media. In certain embodiments, one or more of the Refresh Policies of step 1060 are provided under a Service Level Agreement entered into by and between a data storage services customer and a data storage services provider.

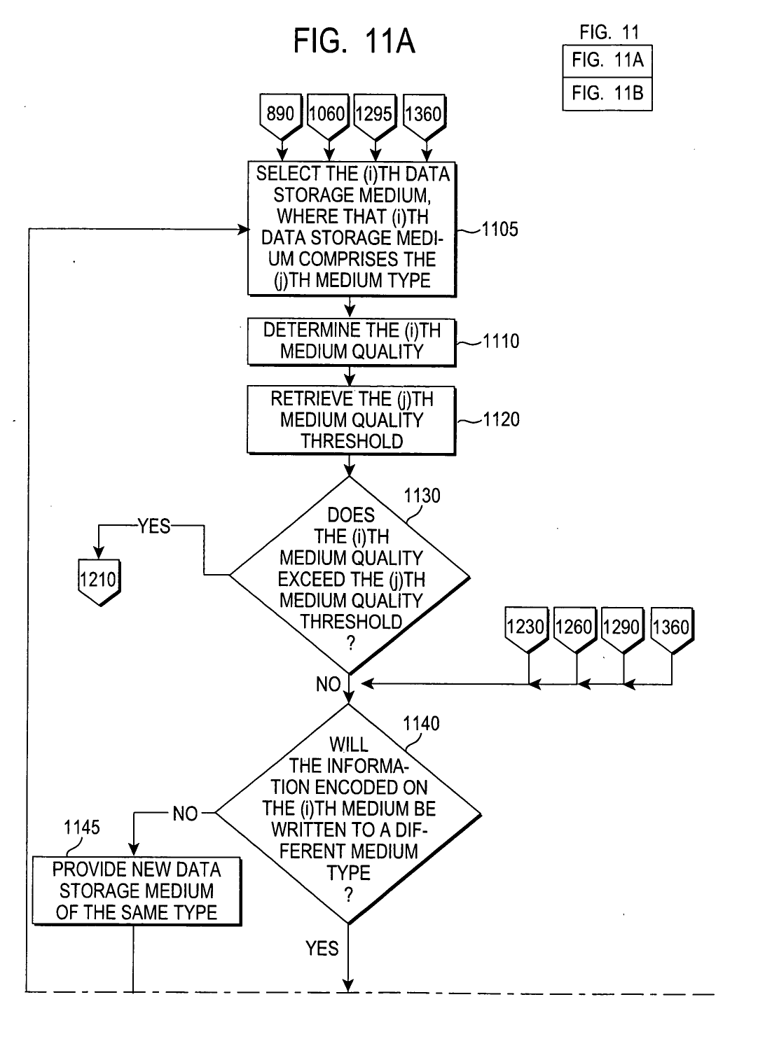

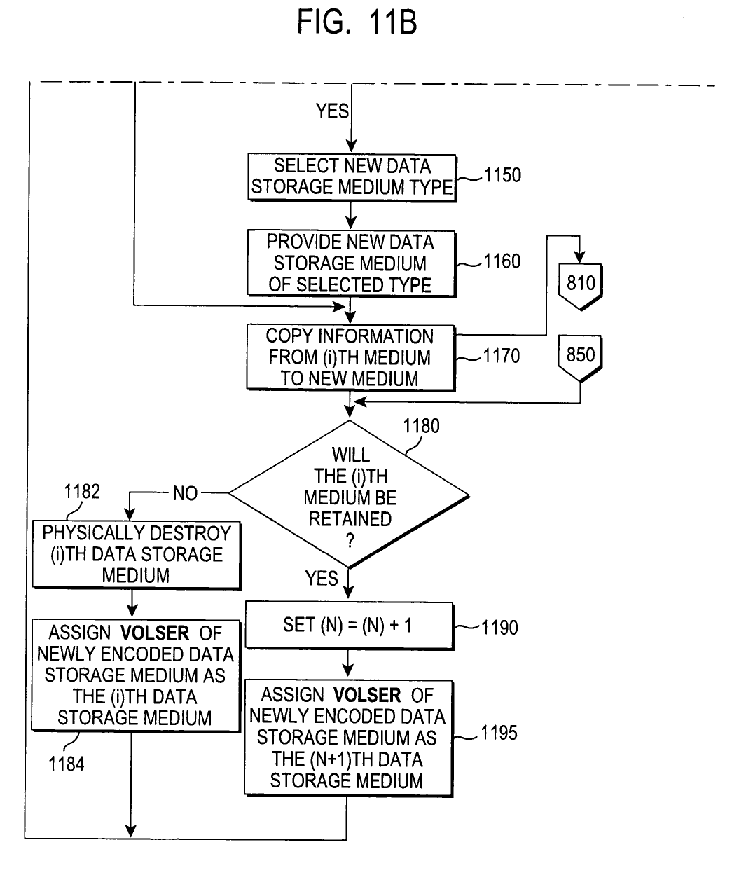

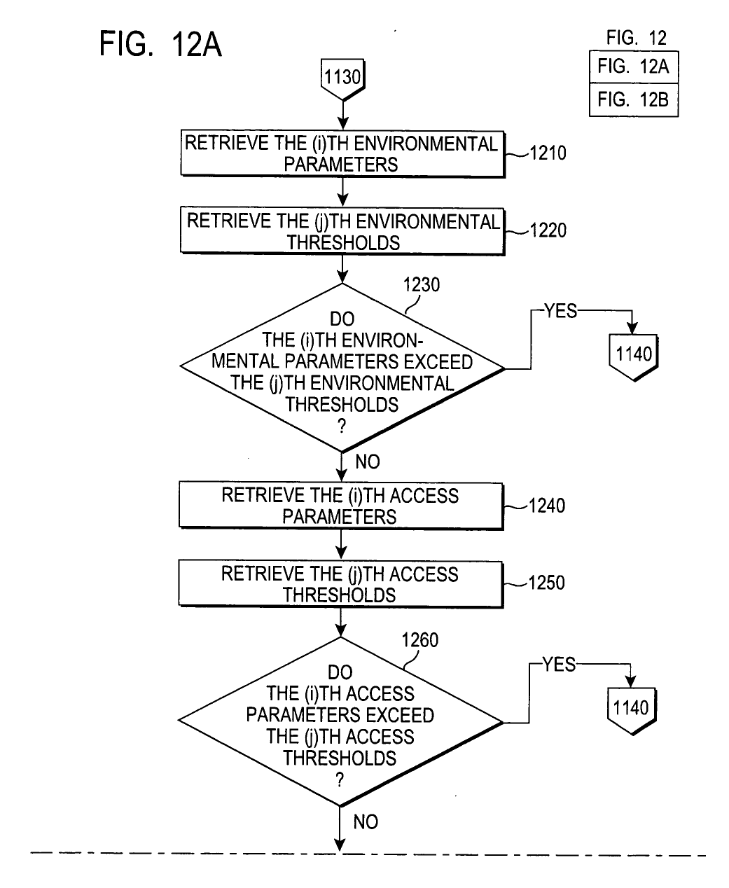

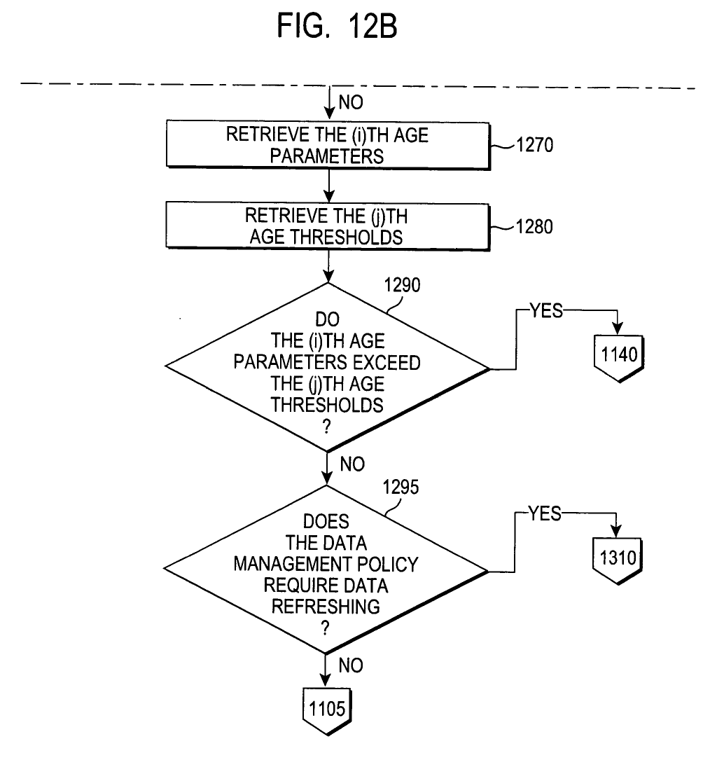

The steps recited in FIG. 10 may be performed in any order. Step 1020 may be performed at any time prior to performing step 1130 (FIG. 11A). Step 1030 may be performed at any time prior to performing step 1260 (FIG. 12A). Step 1040 may be performed at any time prior to performing step 1290 (FIG. 12B). Step 1050 may be performed at any time prior to performing step 1230 (FIG. 12A). Step 1060 may be performed at any time prior to performing step 1295 (FIG. 12B).

Referring now to FIGS. 11A and 11B, in step 1105 Applicants' method selects the (i)th data storage medium, wherein that (i)th data storage medium is one of the (N) data storage media of step 1010, and wherein the (i)th data storage medium comprises the (j)th data storage medium type, wherein the (j)th data storage medium type is one of the (M) data storage media types of step 1010.

Applicants' method transitions from step 1105 to step 1110 wherein the method determines the quality of the selected data storage medium, i.e. the (i)th data storage medium quality. In certain embodiments, step 1110 comprises sampling a percentage of the data encoded on the (i)th data storage medium at one or more locations on the medium. Such data sampling is sometimes referred to as “data scrubbing.” In certain embodiments of Applicants' method, such data scrubbing is performed in the background by controller 80 of FIG. 1 during periods of low utilization of tape storage 91, disk storage 92, and optical storage 93. By periodically sampling the data encoded to the data storage media disposed in the retention management system, Applicants' method can greatly reduce data loss resulting from slowly degrading media. In certain embodiments, excessive occurrences of bad media discovered in step 1110 cause a downward revision in Applicants' Age Thresholds of step 1040.

In certain embodiments wherein the (j)th medium type of step 1105 comprises a hard disk data storage drive type, step 1110 comprises using S.M.A.R.T. technology, i.e. Self Monitoring Analysis And Reporting Technology, encoded in hard disk drive device 92. In these embodiments, controller 80 receives information from the hard disk drive device, and determines the (i)th data storage medium quality using that information. In these embodiments, the information provided to controller 80 by the hard disk drive device includes one or more of the following: the disk “spin up time,” the number of start/stops, the number of hours powered on, and the temperature.

In certain embodiments wherein the (j)th medium type of step 1105 comprises a magnetic tape, step 1110 comprises using SARS technology, i.e. Statistical Analysis And Reporting System, wherein data storage media quality information is read from a tape cartridge by a tape device, such as device 15 (FIGS. 4A, 4B), and wherein the reading tape device provides that information to controller 80 of FIG. 1. The SARS data may be stored on tape 131 (FIG. 6), and/or cartridge memory 103 (FIG. 5).

SARS is implemented in IBM tape drives such as IBM 3590, LTO (Linear Tape Open), IBM 3592. SARS continuously monitors the quality of the media (volume SARS) and also of the hardware, such as the read-write head (hardware SARS). The number of temporary- and permanent read and write errors is recorded and stored on the media itself and in non-volatile memory of the tape drive for each operation. For some tape technologies SARS data is also stored in the cartridge memory 103.

An algorithm examines the error counters of the current and past operation. As a result of this analysis, the tape drive 15 (FIGS. 4A, 4B) posts an informational message when the quality of the media degrades to the controller 80 of the retention management system or the to the host system 61, 62, 63, 64, 65. The informational message is posted via System Information Messages (SIM for IBM 3590) or via Tape Alert Flags (LTO, 3592). In addition, SARS data comprises the total number of bytes read and written to a particular tape cartridge.

In certain embodiments wherein the (j)th medium type of step 1105 comprises an optical disk data storage device type, step 1110 comprises using SARS technology, wherein data storage media quality information is read from an optical disk cartridge by an optical disk data storage device. In these embodiments, the optical disk data storage device provides the SARS information to controller 80 (FIG. 1).

In step 1120, Applicants' method retrieves the (j)th Medium Quality Threshold. In certain embodiments, the (j)th Medium Quality Threshold is retrieved from document management system (“DMS”) 86. In certain embodiments, the (j)th Medium Quality Threshold is retrieved from database 714 disposed in DMS 86. In certain embodiments, step 1120 is performed by a controller, such as controller 80 (FIG. 1) disposed in Applicants' retention management system 90 (FIG. 1). In certain embodiments, step 1120 is performed by a host computer, such as host computer 61 (FIG. 1), in communication with Applicants' retention management system 90.

Applicants' method transitions from step 1120 to step 1130 wherein the method determines if the (i)th medium quality determined in step 1110 is greater than the (j)th Medium Quality Threshold retrieved in step 1120. In certain embodiments, step 1130 is performed by a controller, such as controller 80 (FIG. 1) disposed in Applicants' retention management system 90 (FIG. 1). In certain embodiments, step 1130 is performed by a host computer, such as host computer 61 (FIG. 1), in communication with Applicants' retention management system 90.

If Applicants' method determines in step 1130 that the (i)th medium quality determined in step 1110 is greater than the (j)th Medium Quality Threshold retrieved in step 1120, then the method transitions from step 1130 to step 1210 wherein the method retrieves the environmental parameter for the next medium.

If Applicants' method determines in step 1130 that the (i)th medium quality determined in step 1110 is not greater than the (j)th Medium Quality Threshold retrieved in step 1120, then the method transitions from step 1130 to step 1140 wherein the method determines if the information encoded on the (i)th data storage medium will be written to a different data storage medium type. In certain embodiments, step 1140 is performed using the Data Management Policy of step 1060. In certain embodiments, step 1140 is performed by a controller, such as controller 80 (FIG. 1) disposed in Applicants' retention management system 90 (FIG. 1). In certain embodiments, step 1140 is performed by a host computer, such as host computer 61 (FIG. 1), in communication with Applicants' retention management system 90.

If Applicants' method elects in step 1140 to copy the data from the (i)th data storage medium of the (j)th type to a target data storage medium of the (k)th data storage medium type, wherein (j) is different from (k), then the method transitions from step 1140 to step 1150 wherein the method selects the (k)th data storage medium type. In certain embodiments, step 1150 is performed using instructions provided by the Data Management Policy of step 1060. In certain embodiments, steps 1140 and 1150 are performed substantially synchronously. In certain embodiments, step 1150 is performed by a controller, such as controller 80 (FIG. 1) disposed in Applicants' retention management system 90 (FIG. 1). In certain embodiments, step 1150 is performed by a host computer, such as host computer 61 (FIG. 1), in communication with Applicants' retention management system 90.

Applicants' method transitions from step 1150 to step 1160 wherein the method provides one or more of the data storage media selected in step 1150. In certain embodiments, one or more storage media of the selected data storage media type are disposed within Applicants' retention management system 90, and are available for immediate use. In other embodiments, step 1160 comprises obtaining one or more storage media of the selected data storage media type, and then disposing those newly-obtained data storage media in Applicants' retention management system 90. In certain embodiments, step 1160 comprises providing by a data storage services customer one or more storage media of the selected data storage media type, and then disposing those newly-provided data storage media in Applicants' retention management system 90. In certain embodiments step 1160 comprises obtaining one or more storage media of selected data storage media type from the offline storage 97 and then disposing those newly-obtained data storage media in Applicants' retention management system 90. Applicants' method transitions from step 1160 to step 1170.

If Applicants' method elects in step 1140 to copy the data from the (i)th data storage medium to the (j)th data storage medium type, i.e. the same data storage medium type, then the method transitions from step 1140 to step 1145 wherein the method provides a target data storage medium of the (j)th type.

In certain embodiments, one or more unused storage media of the (j)th storage media type are disposed within Applicants' retention management system 90, and are available for immediate use. In other embodiments, step 1145 comprises obtaining one or more storage media of the (j)th data storage media type, and then disposing those newly-obtained data storage media in Applicants' retention management system 90. In certain embodiments, step 1145 comprises providing by a data storage services customer one or more storage media of the (j)th data storage media type, and then disposing those newly-provided data storage media in Applicants' retention management system 90. In certain embodiments step 1160 comprises obtaining one or more storage media of selected data storage media type from the offline storage 97 and then disposing those newly-obtained data storage media in Applicants' retention management system 90.

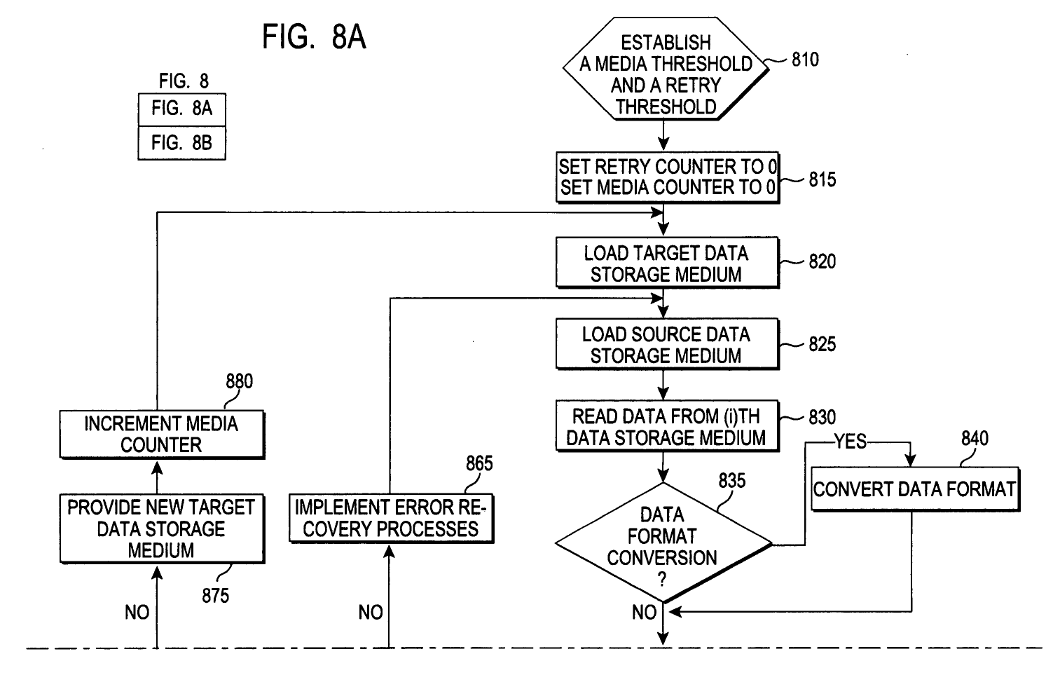

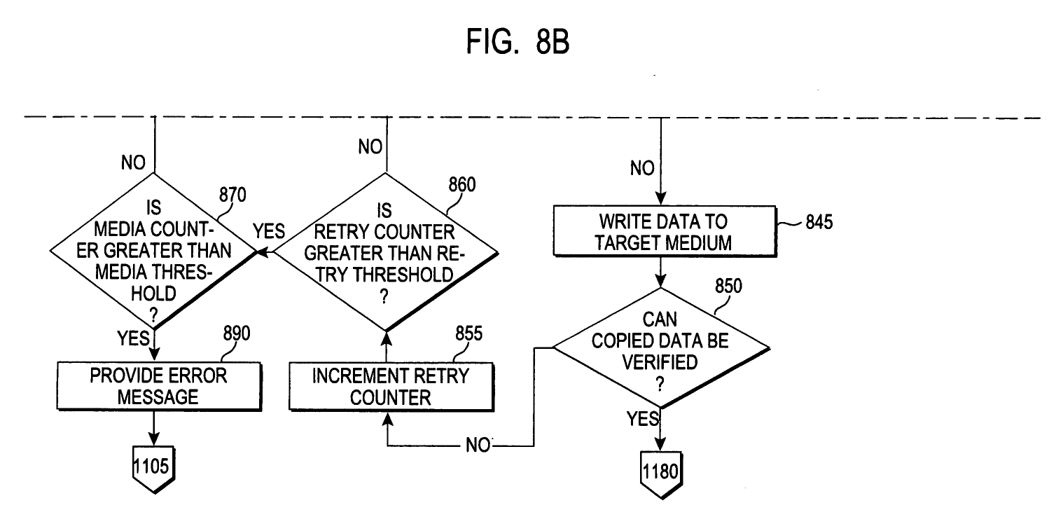

Applicants' method transitions from step 1145 to step 1170 wherein the method copies the data encoded on the (i)th data storage medium to the target data storage medium provided in step 1145 or in step 1160. In certain embodiments, step 1170 comprises the steps recited in FIGS. 8A and 8B.

In certain embodiments, step 1170 is performed by a controller, such as controller 80 (FIG. 1) disposed in Applicants' retention management system 90 (FIG. 1). In certain embodiments, step 1170 is performed by a host computer, such as host computer 61 (FIG. 1), in communication with Applicants' retention management system 90.

In step 1180, Applicants' method determines if the (i)th data storage medium will be retained. In certain embodiments, step 1180 is performed using instructions recited in the Data Management Policy of step 1060. In certain embodiments, step 1180 is performed by a controller, such as controller 80 (FIG. 1) disposed in Applicants' retention management system 90 (FIG. 1). In certain embodiments, step 1180 is performed by a host computer, such as host computer 61 (FIG. 1), in communication with Applicants' retention management system 90.

If Applicants' method elects in step 1180 not to retain the (i)th data storage medium of step 1105, then the method transitions from step 1180 to step 1182 wherein the (i)th data storage medium of step 1105 is physically destroyed. In certain embodiments, step 1182 comprises shredding the (i)th data storage medium. In certain embodiments, step 1182 comprises incinerating the (i)th data storage medium.

Applicants' method transitions from step 1182 to step 1184 wherein the method designates the Volume Serial Number (“VOLSER”) of the target data storage medium provided in step 1145 or step 1160 as the (i)th data storage medium. In certain embodiments, step 1184 comprises updating database 714 to associate the VOLSER of the target data storage medium of step 1170 with the (i)th data storage medium. In certain embodiments, step 1184 is performed by a controller, such as controller 80 (FIG. 1) disposed in Applicants' retention management system 90 (FIG. 1). In certain embodiments, step 1184 is performed by a host computer, such as host computer 61 (FIG. 1), in communication with Applicants' retention management system 90.

Applicants' method then transitions from step 1184 to step 1105 wherein the method selects the next data storage medium.

If Applicants' method elects in step 1180 to retain the (i)th data storage medium of step 1105, then the method transitions from step 1180 to step 1190 wherein the method sets (N) equal to (N)+1. In certain embodiments, step 1190 is performed by a controller, such as controller 80 (FIG. 1) disposed in Applicants' retention management system 90 (FIG. 1). In certain embodiments, step 1190 is performed by a host computer, such as host computer 61 (FIG. 1), in communication with Applicants' retention management system 90.

Applicants' method transitions from step 1190 to step 1195 wherein the method designates the VOLSER of the target data storage medium of step 1170 as the (N+1)th data storage medium. In certain embodiments, step 1195 is performed by a controller, such as controller 80 (FIG. 1) disposed in Applicants' retention management system 90 (FIG. 1). In certain embodiments, step 1195 is performed by a host computer, such as host computer 61 (FIG. 1), in communication with Applicants' retention management system 90.

In certain embodiments, step 1195 comprises updating DMS 86 to associate the VOLSER of the target data storage medium of step 1170 with the (N+1)th data storage medium. In certain embodiments, step 1195 comprises updating database 714 to associate the VOLSER of the target data storage medium of step 1170 as the (i)th data storage medium. Applicants' method transitions from step 1195 to step 1105 and continues as described herein.

If Applicants' method determines in step 1130 that the (i)th data storage medium quality is greater than the (j)th Medium Quality Threshold, then the method transitions from step 1130 to step 1210 (FIG. 12A). Referring now to FIGS. 12A and 12B, in step 1210, Applicants' method retrieves the storage temperature and relative humidity to which the (i)th data storage medium has been exposed, i.e. the (i)th environmental parameters.

In certain embodiments, the (i)th environmental parameters comprise the average storage temperature to which the (i)th data storage medium has been exposed. In certain embodiments, the (i)th environmental parameters comprise the maximum short term storage temperature to which the (i)th data storage medium has been exposed. In certain embodiments the (i)th environmental parameters comprise the average storage temperature and the maximum short term storage temperature to which the (i)th data storage medium has been exposed.

In certain embodiments, the (i)th environmental parameters comprise the average relative humidity to which the (i)th data storage medium has been exposed. In certain embodiments, the (i)th environmental parameters comprise the maximum short term relative humidity to which the (i)th data storage medium has been exposed. In certain embodiments the (i)th environmental parameters comprise the average relative humidity and the maximum short term relative humidity to which the (i)th data storage medium has been exposed.

In certain embodiments, the (i)th environmental parameters are stored in DMS 86 (FIG. 1) and/or database 714 (FIG. 7). In certain embodiments, step 1210 is performed by a controller, such as controller 80 (FIG. 1) disposed in Applicants' retention management system 90 (FIG. 1). In certain embodiments, step 1210 is performed by a host computer, such as host computer 61 (FIG. 1), in communication with Applicants' retention management system 90.

Applicants' method transitions from step 1210 to step 1220 wherein the method retrieves the (j)th Environmental Thresholds. In certain embodiments, step 1220 is performed by a controller, such as controller 80 (FIG. 1) disposed in Applicants' retention management system 90 (FIG. 1). In certain embodiments, step 1220 is performed by a host computer, such as host computer 61 (FIG. 1), in communication with Applicants' retention management system 90.

Applicants' method transitions from step 1220 to step 1230 wherein the method determines if the (i)th environmental parameters are greater than the (j)th Environmental Thresholds. In certain embodiments, step 1230 is performed by a controller, such as controller 80 (FIG. 1) disposed in Applicants' retention management system 90 (FIG. 1). In certain embodiments, step 1230 is performed by a host computer, such as host computer 61 (FIG. 1), in communication with Applicants' retention management system 90.

If Applicants' method determines in step 1230 that the (i)th environmental parameters are greater than the (j)th Environmental Thresholds, then the method transitions from step 1230 to step 1140 and continues as described herein. Alternatively, if Applicants' method determines in step 1230 that the (i)th environmental parameters are not greater than the (j)th Environmental Thresholds, then the method transitions from step 1230 to step 1240 wherein the method retrieves the (i)th access parameters.

In certain embodiments, the (i)th access parameters comprise an access frequency component, such as for example the average time interval between operations wherein information is either written to, or read from, the (i)th data storage medium. In certain embodiments, the (i)th access parameters comprise the number of times information is either written to, or read from, the (i)th data storage medium within a designated time interval. In certain embodiments, the (i)th access parameters comprise an access frequency component and a total number of accesses component.

In certain embodiments, the (i)th access parameters are stored in DMS 86 (FIG. 1) and/or database 714 (FIG. 7). In certain embodiments, step 1240 is performed by a controller, such as controller 80 (FIG. 1) disposed in Applicants' retention management system 90 (FIG. 1). In certain embodiments, step 1240 is performed by a host computer, such as host computer 61 (FIG. 1), in communication with Applicants' retention management system 90.

Applicants' method transitions from step 1240 to step 1250 wherein the method retrieves the (j)th Access Thresholds. In certain embodiments, step 1250 is performed by a controller, such as controller 80 (FIG. 1) disposed in Applicants' retention management system 90 (FIG. 1). In certain embodiments, step 1250 is performed by a host computer, such as host computer 61 (FIG. 1), in communication with Applicants' retention management system 90.

Applicants' method transitions from step 1250 to step 1260 wherein the method determines if the (i)th access parameters are greater than the (j)th Access Thresholds. In certain embodiments, step 1260 is performed by a controller, such as controller 80 (FIG. 1) disposed in Applicants' retention management system 90 (FIG. 1). In certain embodiments, step 1260 is performed by a host computer, such as host computer 61 (FIG. 1), in communication with Applicants' retention management system 90.

If Applicants' method determines in step 1260 that the (i)th access parameters are greater than the (j)th Access Thresholds, then the method transitions from step 1260 to step 1140 and continues as described herein. Alternatively, if Applicants' method determines in step 1260 that the (i)th access parameters are not greater than the (j)th Access Thresholds, then the method transitions from step 1260 to step 1270 wherein the method retrieves the (i)th age parameters.

In certain embodiments, the (i)th age parameters are stored in DMS 86 (FIG. 1) and/or database 714 (FIG. 7). In certain embodiments, step 1270 is performed by a controller, such as controller 80 (FIG. 1) disposed in Applicants' retention management system 90 (FIG. 1). In certain embodiments, step 1270 is performed by a host computer, such as host computer 61 (FIG. 1), in communication with Applicants' retention management system 90.

Applicants' method transitions from step 1270 to step 1280 wherein the method retrieves the (j)th Age Thresholds. In certain embodiments, step 1280 is performed by a controller, such as controller 80 (FIG. 1) disposed in Applicants' retention management system 90 (FIG. 1). In certain embodiments, step 1280 is performed by a host computer, such as host computer 61 (FIG. 1), in communication with Applicants' retention management system 90.

Applicants' method transitions from step 1280 to step 1290 wherein the method determines if the (i)th age parameters are greater than the (j)th Age Thresholds. In certain embodiments, step 1290 is performed by a controller, such as controller 80 (FIG. 1) disposed in Applicants' retention management system 90 (FIG. 1). In certain embodiments, step 1290 is performed by a host computer, such as host computer 61 (FIG. 1), in communication with Applicants' retention management system 90.

If Applicants' method determines in step 1290 that the (i)th age parameters are greater than the (j)th Age Thresholds, then the method transitions from step 1290 to step 1140 and continues as described herein. Alternatively, if Applicants' method determines in step 1290 that the (i)th age parameters are not greater than the (j)th Age Thresholds, then the method transitions from step 1290 to step 1295 wherein the method determines if the Data Management Policy of step 1060 requires refreshing the data encoded on the (i)th data storage medium. In certain embodiments, step 1295 is performed by a controller, such as controller 80 (FIG. 1) disposed in Applicants' retention management system 90 (FIG. 1). In certain embodiments, step 1295 is performed by a host computer, such as host computer 61 (FIG. 1), in communication with Applicants' retention management system 90.

If Applicants' method determines in step 1295 that the Data Management Policy does not require that the data encoded to the (i)th data storage medium be refreshed, then the method transitions from step 1295 to step 1105 and continues as described herein.

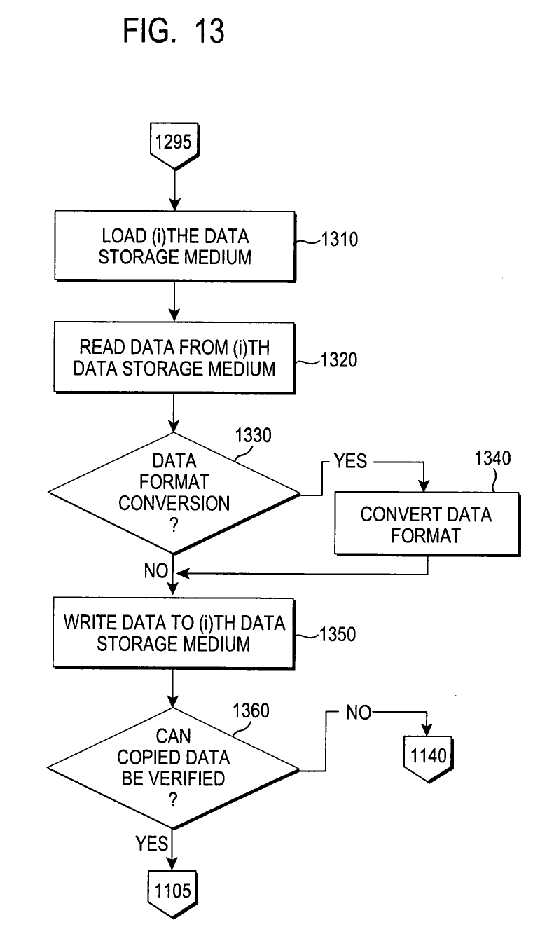

Alternatively, if Applicants' method determines in step 1295 that the Data Management Policy requires the data encoded on the (i)th data storage medium be refreshed, then the method transitions from step 1295 to step 1310 (FIG. 13) wherein Applicants' method loads in an appropriate data storage device the (i)th data storage medium of step 1105. In certain embodiments, step 1310 is performed manually. In other embodiments, step 1310 is performed by a robotic accessor in response to commands provided by controller 80 and/or an interconnected host computer.

Applicants' method transitions from step 1310 to step 1320 wherein the data storage device of step 1310 reads the data encoded to the (i)th data storage medium. In step 1330, Applicants' method determines if a data format conversion will take place during the copy process. For example, it might be necessary to convert data from TIF format to PDF format.

In certain embodiments, the decision of step 1330 is based on criteria, such as the availability of a new format and a converter from the old format to the new format, or the obsolescence of the old data format requiring the conversion to the new format, or the existence of the new technology, wherein step 1330 also comprises selecting the new data format. The conversion to a new format may be driven whether there is a current application which can process that data. If there is no longer a current application which can process that data, or the application which can process that data is at end-of-life, then the data needs to be converted to another format which compatible with an existing application.

In certain embodiments, the decision of step 1330 is performed using instructions provided by the Data Management Policy of step 1060 (FIG. 10). In certain embodiments, step 1330 is performed by a controller, such as controller 80 (FIG. 1) disposed in Applicants' retention management system 90 (FIG. 1). In certain embodiments, step 1330 is performed by a host computer, such as host computer 61 (FIG. 1), in communication with Applicants' retention management system 90.

If Applicants' method determines in step 1330 that a data format conversion will not be implemented, then the method transitions from step 1330 to step 1350. Alternatively, if Applicants' method determines in step 1330 that a data format conversion will be implemented, then the method transitions from step 1330 to step 1340 wherein the method converts the data read from the (i)th data storage medium in step 1320 in an existing data format to the new data format selected in step 1330. In certain embodiments, step 1340 is performed by a controller, such as controller 80 (FIG. 1) disposed in Applicants' retention management system 90 (FIG. 1). In certain embodiments, step 1340 is performed by a host computer, such as host computer 61 (FIG. 1), in communication with Applicants' retention management system 90.

Applicants' method transitions from step 1340 to step 1350 wherein the data storage device writes the data read in step 1320 to (i)th data storage medium. In step 1360, Applicants' method attempts to verify the data written in step 845. In certain embodiments, step 1360 comprises calculating a checksum on the data encoded to the target data storage medium and comparing that checksum to the checksum for the (i)th data storage medium, i.e. the (i)th checksum, wherein that (i)th checksum is stored in DMS 86 (FIG. 1) and/or database 714 (FIG. 7). In certain embodiments, step 850 comprises performing an LRC or a CRC (cyclical redundancy check) check on the data encoded to the target data storage medium, and comparing the LRC and/or CRC results to the (i)th LRC/(i)th CRC values written to DMS 86 and/or database 714.

In certain embodiments, step 1360 is performed by a controller, such as controller 80 (FIG. 1) disposed in Applicants' retention management system 90 (FIG. 1). In certain embodiments, step 1360 is performed by a host computer, such as host computer 61 (FIG. 1), in communication with Applicants' retention management system 90.

If Applicants' method in step 1360 verifies the data written in step 1350, then the method transitions from step 1360 to step 1105 (FIG. 11A), and continues as described herein. Alternatively, if Applicants' method cannot in step 1360 verify the data written in step 1350, then the method transitions from step 1360 to 1140 and continues as described herein.

In certain embodiments, step 1170 (FIG. 11B) comprises the steps recited in FIGS. 8A and 8B. Referring now to FIGS. 8A and 8B, in step 810 Applicants' method establishes a Media Threshold and a Retry Threshold. In certain embodiments, the Media Threshold and/or the Retry Threshold are provided by a host computer in communication with Applicants' retention management system. In certain embodiments, the Media Threshold and/or the Retry Threshold are established by the owner/operator of Applicants' retention management system. In certain embodiments, Media Threshold and/or the Retry Threshold are specified in the Data Management Policy of step 1060.

In step 815, Applicants' method provides and sets a Retry Counter to 0. Further in step 815, Applicants' method provides and sets a Media Counter to 0. In certain embodiments, step 815 is performed by a controller, such as controller 80 (FIG. 1) disposed in Applicants' retention management system 90 (FIG. 1). In certain embodiments, step 815 is performed by a host computer, such as host computer 61 (FIG. 1), in communication with Applicants' retention management system 90.

In step 820, Applicants' method loads in an appropriate data storage device the target storage medium provided in step 1145 or in step 1160. Step 820 may be performed at any time prior to performing step 845. In certain embodiments, step 820 is performed manually. In other embodiments, step 820 is performed by a robotic accessor in response to commands provided by controller 80 and/or an interconnected host computer.

In step 825, Applicants' method loads in an appropriate data storage device the (i)th data storage medium of step 1105. Step 825 may be performed at any time prior to performing step 830. In certain embodiments, step 825 is performed manually. In other embodiments, step 825 is performed by a robotic accessor in response to commands provided by controller 80 and/or an interconnected host computer.

Applicants' method transitions from step 825 to step 830 wherein the data storage device of step 825 reads the data encoded to the (i)th data storage medium. In step 835, Applicants' method determines if a data format conversion will take place during the copy process. For example, it might be necessary to convert data from TIF format to PDF format. In certain embodiments, the decision of step 835 is based on criteria, such as the availability of a new format and a converter from the old format to the new format, or the obsolescence of the old data format requiring the conversion to the new format, or the existence of the new technology. The conversion to a new format may be driven whether there is a current application which can process that data. If there is no longer a current application which can process that data, or the application which can process that data is at end-of-life, then the data needs to be converted to another format which compatible with an existing application.

In certain embodiments, the decision of step 835 is performed using instructions provided by the Data Management Policy of step 1060 (FIG. 10), wherein step 835 also comprises selecting the new data format. In certain embodiments, step 835 is performed by a controller, such as controller 80 (FIG. 1) disposed in Applicants' retention management system 90 (FIG. 1). In certain embodiments, step 835 is performed by a host computer, such as host computer 61 (FIG. 1), in communication with Applicants' retention management system 90.

If Applicants' method determines in step 835 that a data format conversion will not be implemented, then the method transitions from step 835 to step 845 (FIG. 8B). Alternatively, if Applicants' method determines in step 835 that a data format conversion will be implemented, then the method transitions from step 835 to step 840 wherein the method converts the data read from the (i)th data storage medium in step 825 in an existing data format to the new data format selected in step 835. In certain embodiments, step 840 is performed by a controller, such as controller 80 (FIG. 1) disposed in Applicants' retention management system 90 (FIG. 1). In certain embodiments, step 840 is performed by a host computer, such as host computer 61 (FIG. 1), in communication with Applicants' retention management system 90.

Referring now to FIG. 8B, Applicants' method transitions from step 840 (FIG. 8A) to step 845 wherein the data storage device comprising the target data storage medium writes the data to the target data storage medium. In step 850, Applicants' method attempts to verify the data written in step 845. In certain embodiments, step 850 comprises calculating a checksum on the data encoded to the target data storage medium and comparing that checksum to the checksum for the (i)th data storage medium, i.e. the (i)th checksum, wherein that (i)th checksum is stored in DMS 86 (FIG. 1) and/or database 714 (FIG. 7). In certain embodiments, step 850 comprises performing an LRC or a CRC check on the data encoded to the target data storage medium, and comparing the LRC and/or CRC results to the (i)th LRC/(i)th CRC values written to DMS 86 and/or database 714.

In certain embodiments, step 850 is performed by a controller, such as controller 80 (FIG. 1) disposed in Applicants' retention management system 90 (FIG. 1). In certain embodiments, step 850 is performed by a host computer, such as host computer 61 (FIG. 1), in communication with Applicants' retention management system 90.

If Applicants' method verifies in step 850 the data written in step 845, then the method transitions from step 845 to step 1180 (FIG. 11B), and continues as described herein. Alternatively, if Applicants' method cannot verify in step 850 the data written in step 845, then the method transitions from step 845 to step 855 wherein the method increments by unity the Retry Counter. In certain embodiments, step 855 is performed by a controller, such as controller 80 (FIG. 1) disposed in Applicants' retention management system 90 (FIG. 1). In certain embodiments, step 855 is performed by a host computer, such as host computer 61 (FIG. 1), in communication with Applicants' retention management system 90.

Applicants' method transitions from step 855 to step 860 wherein the method determines if the Retry Counter is greater than the Retry Threshold. In certain embodiments, step 860 is performed by a controller, such as controller 80 (FIG. 1) disposed in Applicants' retention management system 90 (FIG. 1). In certain embodiments, step 860 is performed by a host computer, such as host computer 61 (FIG. 1), in communication with Applicants' retention management system 90.

If Applicants' method determines in step 860 that the Retry Counter is not greater than the Retry Threshold, then the method transitions from step 860 to step 865 (FIG. 8A) wherein the method, using the data storage device comprising the (i)th data storage medium, implements appropriate error recovery procedures (“ERPs”). In certain embodiments, the ERPs of step 865 include dismounting and then again mounting the (i)th data storage medium.

In certain embodiments, the ERPs of step 865 comprise additional procedures. As those skilled in the art will appreciate, the error recovery procedures (“ERPs”) of step 865 are dependent on the storage media. For example, for hard disks the ERPs of step 865 comprise a media scan. On the other hand, for tape media the ERPs of step 865 comprise a tape locate followed by a tape rewind. For optical storage media, the ERPS of step 865 comprise a reload of the disk. Applicants' method transitions from step 865 to step 825, and continues as described herein.

If Applicants' method determines in step 860 that the Retry Counter is greater than the Retry Threshold, then the method transitions from step 860 to step 870 wherein the method determines if the media counter is greater than the Media Threshold. In certain embodiments, step 870 is performed by a controller, such as controller 80 (FIG. 1) disposed in Applicants' retention management system 90 (FIG. 1). In certain embodiments, step 870 is performed by a host computer, such as host computer 61 (FIG. 1), in communication with Applicants' retention management system 90.

If Applicants' method determines in step 870 that the media counter is not greater than the Media Threshold, then the method transitions from step 870 to step 875 wherein the method provides a new target data storage medium in accord with the decision of step 1140 (FIG. 11A). In step 880, Applicants' method increments by unity the Media Counter. In certain embodiments, step 880 is performed by a controller, such as controller 80 (FIG. 1) disposed in Applicants' retention management system 90 (FIG. 1). In certain embodiments, step 880 is performed by a host computer, such as host computer 61 (FIG. 1), in communication with Applicants' retention management system 90. Applicants' method transitions from step 880 to step 820 and continues as described herein.

If Applicants' method determines in step 870 that the media counter is greater than the Media Threshold, then the method transitions from step 870 to step 890 wherein the method provides an error message. In certain embodiments, the error message of step 890 is provided by Applicants' retention management system to one or more interconnected host computers. In certain embodiments, step 890 is performed by a controller, such as controller 80 (FIG. 1) disposed in Applicants' retention management system 90 (FIG. 1). In certain embodiments, step 890 is performed by a host computer, such as host computer 61 (FIG. 1), in communication with Applicants' retention management system 90. Applicants' method transitions from step 890 to step 1105 and continues as described herein.

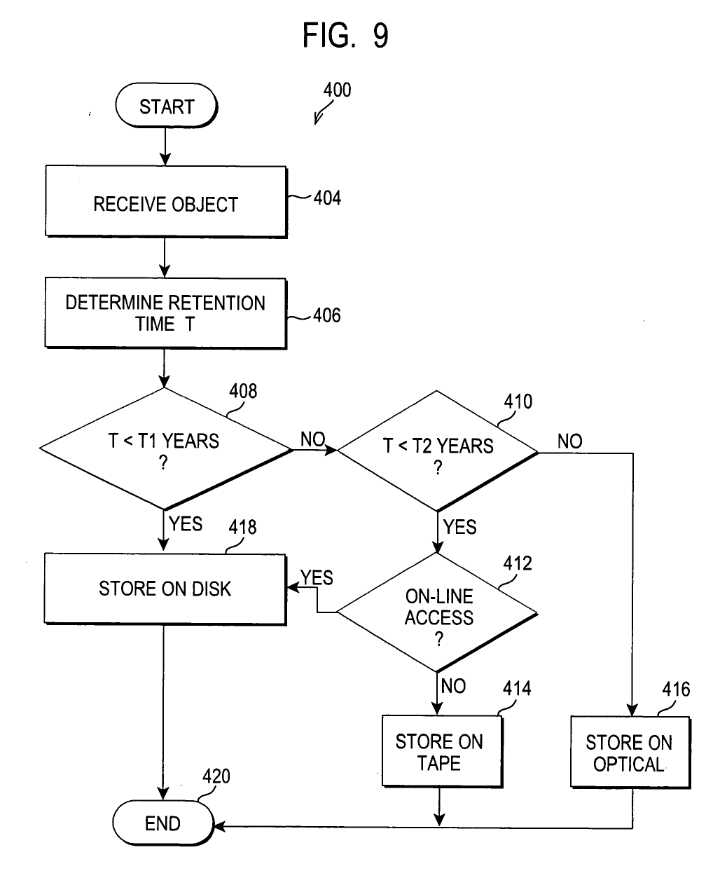

FIG. 9 summarizes Applicants' process 400 to select the appropriate storage medium based upon the retention time and access requirements of the data. In step 404, Applicants' retention management system 90 receives a data object and user defined retention time T from one of hosts 61-65. In one embodiment, the object is associated directly with a retention time. In this embodiment, one of the host systems 61-65 send the retention time explicitly as part of the store request with the data object. In another embodiment, the object is associated with a management class which is defined in the Data Management Policy. In still other embodiments, the file-name of the object designates the retention time.

In step 406, Applicants' method identifies retention time T from the information send by one of hosts 61-65. In certain embodiments, step 406 is performed by a controller, such as controller 80 (FIG. 1) disposed in Applicants' retention management system 90 (FIG. 1). In step 408, Applicants' method determines whether the retention time T is less than threshold T1. In certain embodiments, threshold T1 is set to 1 year.

If Applicants' method determines in step 408 that retention time T is less than threshold T1, then the method transitions from step 408 to step 418 and the method stores the data on hard disk. Storing an object with a low retention time on a hard-disk means that the space occupied by the object will be freed-up soon and the access time to the object on disk is optimal. Applicants' method transitions from step 418 to step 420 and ends.

If Applicants' method determines in step 408 that retention time T is not less than threshold T1, then the method transitions from step 408 to step 410 wherein the method determines if the retention time T is less than threshold T2. In certain embodiments, step 410 is performed by a controller, such as controller 80 (FIG. 1) disposed in Applicants' retention management system 90 (FIG. 1). In certain embodiments, threshold T2 is set to 10 years.

If Applicants' method determines in step 410 that retention time T is less than threshold T2, then the method transitions from step 410 to step 412 wherein the method determines if on-line access is required. In certain embodiments, step 412 is performed by a controller, such as controller 80 (FIG. 1) disposed in Applicants' retention management system 90 (FIG. 1). In certain embodiments, an on-line access requirement is provided by the host computer in combination with the data object.

If Applicants' method determines in step 412 that on-line access is required, then the method transitions from step 412 to step 418. Alternatively, if Applicants' method determines in step 412 that on-line access is not required, then the method transitions from step 412 to step 414 wherein the method writes the data object of step 404 to magnetic tape. As those skilled in the art will appreciate, the retention time of the object can be correlated to the lifetime of a tape. Applicants' method transitions from step 414 to step 420 and ends.

If Applicants' method determines in step 410 that retention time T is not less than threshold T2, then the method transitions from step 410 to step 416 wherein the method writes the data object of step 404 to one or more optical data storage media. As those skilled in the art will appreciate, if the retention time exceeds the lifetime of magnetic tape data storage media, then the most efficient way to store the data uses one or more optical storage media having a longer lifetime than tape. Applicants' method transitions from step 416 to step 420 and ends. After the data is written to an appropriate data storage medium using the steps of FIG. 9, Applicants' method of FIGS. 10, 11, 12, and 13, are subsequently invoked.

In certain embodiments of Applicants' method, a data storage services customer is charged per gigabyte (GB) or megabyte (MB) of data stored, depending on the destination storage, as determined using FIG. 9. In certain embodiments, Applicants' method establishes a first $/GB fee for hard disk storage, a second $/GB fee for optical storage, and a third $/GB fee for tape storage. In certain embodiments, these storage fees are assessed when the data is first stored. In other embodiments, the storage fees are assessed on a periodic basis, such as daily, weekly, or monthly, for the rental of the storage.

In certain embodiments, Applicants' method further establishes a fee structure for the migration of data. In certain embodiments, such a data migration fee comprises a charge for the storage media, charges based upon the amount of data to be migrated. In addition, in certain embodiments Applicants' method charges a format conversion fee per GB of data reformatted, if format conversion is utilized.

In certain embodiments, Applicants' method further establishes a fee structure for copying data. In certain embodiments, such a data copy fee comprises a charge for the storage media, and charges based upon the amount of data to be copied. In addition, in certain embodiments Applicants' method charges a format conversion fee per GB of data reformatted, if format conversion is utilized.

In certain embodiments, Applicants' method further establishes a fee structure for the data refreshing of FIG. 13. In certain embodiments, such a data refresh fee structure comprises a normal technique policy comprising a first price, and an enhanced technique policy comprising a second, higher price. Such an enhanced technique fee structure is triggered by external events.

In certain embodiments, Applicants' method further establishes a fee structure for the data format conversion of FIG. 13 and FIG. 8. In certain embodiments, such a data format conversion fee structure comprises a normal technique policy comprising a first price, and an enhanced technique policy comprising a second, higher price. Such an enhanced technique fee structure is triggered by external events. In other embodiments such as data format conversion fee structure is based on the amount of data being converted.

In certain embodiments, such an external event comprises a notification regarding the obsolescence of a storage media technology, or the obsolescence of a certain data format. In other embodiments, such an external event comprises a notification, based upon historical data, that a designated storage technology starts to decline with reference to its storage characteristics.

In certain embodiments, the steps of FIGS. 8A, 8B, FIG. 9, FIG. 10, FIG. 11A, 11B, FIG. 12A, 12B, and/or FIG. 13, may be implemented separately. In certain embodiments, individual steps recited in FIGS. 8A, 8B, FIG. 9, FIG. 10, FIG. 11A, 11B, FIG. 12A, 12B, and/or FIG. 13, may be combined, eliminated, or reordered.

In certain embodiments, Applicants' invention includes instructions residing in memory, such as for example RAM memory 84 (FIG. 1) and/or Nonvolatile Memory 83 (FIG. 1), where those instructions are executed by a processor, such as processor 82 (FIG. 1), to perform steps 815, 820, 825, 830, 835, 840, 845, 850, 855, 860, 865, 870, 875, 880, and/or 890, recited in FIGS. 8A and 8B, and/or steps 404, 406, 408, 410, 412, 414, 416, and/or 418, recited in FIG. 9, and/or steps 1105, 1110, 1120, 1130, 1140, 1145, 1150, 1160, 1170, 1180, 1182, 1184, 1190, and/or 1195, recited in FIGS. 11A and 11B, and/or steps 1210, 1220, 1230, 1240, 1250, 1260, 1270, 1280, 1290, and/or 1295, recited in FIGS. 12A and 12B, and/or steps 1310, 1320, 1330, 1340, 1350, and/or 1360, recited in FIG. 13.

In other embodiments, Applicants' invention includes instructions residing in any other computer program product, where those instructions are executed by a computer external to, or internal to, system 90, to perform steps 815, 820, 825, 830, 835, 840, 845, 850, 855, 860, 865, 870, 875, 880, and/or 890, recited in FIG. 8, and/or steps 404, 406, 408, 410, 412, 414, 416, and/or 418, recited in FIG. 9, and/or steps 1105, 1110, 1120, 1130, 1140, 1145, 1150, 1160, 1170, 1180, 1182, 1184, 1190, and/or 1195, recited in FIGS. 11A and 11B, and/or steps 1210, 1220, 1230, 1240, 1250, 1260, 1270, 1280, 1290, and/or 1295, recited in FIGS. 12A and 12B, and/or steps 1310, 1320, 1330, 1340, 1350, and/or 1360, recited in FIG. 13.

In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A data management method, comprising the steps of:
providing (N) data storage media comprising information, wherein each of said (N) data storage media comprises one of (M) media types, wherein (N) is greater than or equal to 1, and wherein (M) is greater than or equal to 1;
establishing a Media Quality Threshold for each of said (M) media types;
establishing an Access Threshold for each of said (M) media types;
establishing an Age Threshold for each of said (M) media types;
establishing an Environmental Threshold for each of said (M) media types;
establishing a Data Management Policy for each of said (M) media types;

2. The method of claim 1, further comprising the steps of:
selecting the (i)th data storage medium, wherein said (i)th data storage medium is one of said (N) data storage media, and wherein said (i)th data storage medium comprises the (j)th media type, wherein the (j)th media type is one of said (M) media types;
determining the (i)th medium quality;
ascertaining if the (i)th medium quality is greater than the (j)th Media Quality Threshold;
operative if the (i)th medium quality is not greater than the O)th Media Quality Threshold:
supplying a new data storage medium, wherein said new data storage medium is not one of said (N) data storage media; and
copying the information encoded on said (i)th data storage medium to said new data storage medium.

3. The method of claim 2, wherein said new data storage medium comprises a VOLSER, further comprising the steps of:
determining if the (i)th data storage medium will be retained;
operative if the (i)th data storage medium will not be retained:
destroying said (i)th data storage medium after performed said copying step;
associating said VOLSER with the (i)th data storage medium.

4. The method of claim 3, further comprising the steps of:
operative if the (i)th data storage medium will be retained:
setting (N) equal to (N+1); and
associating said VOLSER with the (N+1)th data storage medium.

5. The method of claim 1, further comprising the steps of:
operative if the (i)th medium quality is greater than the (j)th Media Quality Threshold:
determining the (i)th environmental parameters;
retrieving the (j)th Environmental Threshold;
determining if said (i)th environmental parameters are greater than the (j)th Environmental Threshold;
operative if said (i)th environmental parameters are greater than the (j)th Environmental Threshold:
supplying a new data storage medium, wherein said new data storage medium is not one of said (N) data storage media; and
copying the information encoded on said (i)th data storage medium to said new data storage medium.

6. The method of claim 5, further comprising the steps of:
operative if the (i)th environmental parameters are greater than the (j)th Environmental Threshold:
determining the (i)th access parameters;
retrieving the (j)th Access Threshold;
determining if said (i)th access parameters are greater than the (j)th Access Threshold;
operative if said (i)th access parameters are greater than the (j)th Access Threshold:
supplying a new data storage medium, wherein said new data storage medium is not one of said (N) data storage media; and
copying the information encoded on said (i)th data storage medium to said new data storage medium.

7. The method of claim 6, further comprising the steps of:
operative if the (i)th access parameters are greater than the (j)th Access Threshold:
determining the (i)th age parameters;
retrieving the (j)th Age Threshold;
determining if said (i)th age parameters are greater than the (j)th Age Threshold;
operative if said (i)th age parameters are greater than the (j)th Age Threshold:
supplying a new data storage medium, wherein said new data storage medium is not one of said (N) data storage media; and
copying the information encoded on said (i)th data storage medium to said new data storage medium.

8. The method of claim 7, further comprising the steps of:
operative if the (i)th age parameters are greater than the (j)th Age Threshold:
determining if said Data Management Policy requires that the (i)th data storage medium be refreshed;
operative if said Data Management Policy requires that the (i)th data storage medium be refreshed:
loading the (i)th data storage medium in a data storage device capable of reading data encoded on said (i)th data storage medium and encoding data on said (i)th data storage medium;
reading said information encoded on said (i)th data storage medium, wherein said information is encoded on said (i)th data storage medium in a first format;
determining if said Data Management Policy requires a format conversion;
operative if said Data Management Policy does not requires a format conversion, writing said information in said first format to said (i)th data storage medium;
operative if said Data Management Policy does requires a format conversion:
converting said information from said first format to a second format;
writing said information in said second format to said (i)th data storage medium.

9. The method of claim 7, wherein said establishing an Access Threshold further comprises establishing an Access Threshold comprising an access frequency component and a total number of accesses component, wherein said access frequency component comprises the average time interval between operations wherein information is either written to, or read from, a data storage medium, and wherein said total number of accesses component comprises the number of times information is either written to, or read from, a data storage medium within a designated time interval.

10. The method of claim 9, wherein said establishing an Environmental Threshold further comprises establishing an Environmental Threshold comprising a maximum acceptable average storage temperature, a maximum acceptable short term storage temperature, a maximum acceptable average relative humidity, a maximum acceptable short term storage relative humidity.

11. An article of manufacture comprising (N) data storage media, wherein each of said (N) data storage media comprises one of (M) media types, wherein (N) is greater than or equal to 1, and wherein (M) is greater than or equal to 1, a pre-determined Media Quality Threshold for each of said (M) media types, a pre-determined Access Threshold for each of said (M) media types, a pre-determined Age Threshold for each of said (M) media types, a pre-determined Environmental Threshold for each of said (M) media types, a pre-determined Data Management Policy for each of said (M) media types, and a computer useable medium having computer readable program code disposed therein to manage the information encoded in said (N) data storage media, the computer readable program code comprising a series of computer readable program steps to effect:
selecting the (i)th data storage medium, wherein said (i)th data storage medium is one of said (N) data storage media, and wherein said (i)th data storage medium comprises the (j)th media type, wherein the (j)th media type is one of said (M) media types;
determining the (i)th data storage medium quality;
ascertaining if the (i)th medium quality is greater than the (j)th Media Quality Threshold;
operative if the (i)th medium quality is not greater than the O)th Media Quality Threshold, copying the information encoded on said (i)th data storage medium to a new data storage medium.

12. The article of manufacture of claim 11, said computer readable program code further comprising a series of computer readable program steps to effect, based upon said Data Management Policy, selecting the (k)th media type for said new data storage medium, wherein said (k)th media type is one of said (M) media types;

13. The article of manufacture of claim 12, wherein said new data storage medium comprises a VOLSER, said computer readable program code further comprising a series of computer readable program steps to effect:
based upon said Data Management Policy, determining if the (i)th data storage medium will be retained;
operative if the (i)th data storage medium will not be retained:
destroying said (i)th data storage medium after performed said copying step;
associating said VOLSER with the (i)th data storage medium.

14. The article of manufacture of claim 3, said computer readable program code further comprising a series of computer readable program steps to effect:
operative if the (i)th data storage medium will be retained:
setting (N) equal to (N+1); and
associating said VOLSER with the (N+1)th data storage medium.

15. The article of manufacture of claim 11, said computer readable program code further comprising a series of computer readable program steps to effect:
operative if the (i)th medium quality is greater than the (j)th Media Quality Threshold:
determining the (i)th environmental parameters;
retrieving the (j)th Environmental Threshold;
determining if said (i)th environmental parameters are greater than the (j)th Environmental Threshold;
operative if said (i)th environmental parameters are greater than the (j)th Environmental Threshold:
copying the information encoded on said (i)th data storage medium to a new data storage medium.

16. The article of manufacture of claim 15, said computer readable program code further comprising a series of computer readable program steps to effect:
operative if the (i)th environmental parameters are greater than the (j)th Environmental Threshold:
determining the (i)th access parameters;
retrieving the (j)th Access Threshold;
determining if said (i)th access parameters are greater than the (j)th Access Threshold;
operative if said (i)th access parameters are greater than the (j)th Access Threshold:
copying the information encoded on said (i)th data storage medium to a new data storage medium.

17. The article of manufacture of claim 16, said computer readable program code further comprising a series of computer readable program steps to effect:
operative if the (i)th access parameters are not greater than the (j)th Access Threshold:
determining the (i)th age parameters;
retrieving the (j)th Age Threshold;
determining if said (i)th age parameters are greater than the (j)th Age Threshold;
operative if said (i)th age parameters are greater than the (j)th Age Threshold:
copying the information encoded on said (i)th data storage medium to a new data storage medium.

18. The article of manufacture of claim 17, said computer readable program code further comprising a series of computer readable program steps to effect:
operative if the (i)th age parameters are greater than the (j)th Age Threshold:
determining if said Data Management Policy requires that the (i)th data storage medium be refreshed;
operative if said Data Management Policy requires that the (i)th data storage medium be refreshed:
loading the (i)th data storage medium in a data storage device capable of reading data encoded on said (i)th data storage medium and encoding data on said (i)th data storage medium;
reading said information encoded on said (i)th data storage medium, wherein said information is encoded on said (i)th data storage medium in a first format;
determining if said Data Management Policy requires a format conversion;
operative if said Data Management Policy does not requires a format conversion, writing said information in said first format to said (i)th data storage medium;
operative if said Data Management Policy does requires a format conversion:
converting said information from said first format to a second format;
writing said information in said second format to said (i)th data storage medium.

19. A computer program product usable with a programmable computer processor having computer readable program code embodied therein to manage information encoded in (N) data storage media, wherein each of said (N) data storage media comprises one of (M) media types, wherein (N) is greater than or equal to 1, and wherein (M) is greater than or equal to 1, a pre-determined Media Quality Threshold for each of said (M) media types, a pre-determined Access Threshold for each of said (M) media types, a pre-determined Age Threshold for each of said (M) media types, a pre-determined Environmental Threshold for each of said (M) media types, a predetermined Data Management Policy for each of said (M) media types, comprising:
computer readable program code which causes said programmable computer processor to select the (i)th data storage medium, wherein said (i)th data storage medium is one of said (N) data storage media, and wherein said (i)th data storage medium comprises the (j)th media type, wherein the (j)th media type is one of said (M) media types;
computer readable program code which causes said programmable computer processor to determine the (i)th data storage medium quality;
computer readable program code which causes said programmable computer processor to ascertain if the (i)th medium quality is greater than the (j)th Media Quality Threshold;
computer readable program code which, if the (i)th medium quality is not greater than the (j)th Media Quality Threshold, causes said programmable computer processor to copy the information encoded on said (i)th data storage medium to a new data storage medium.

20. The computer program product of claim 19, further comprising computer readable program code which causes said programmable computer processor to, based upon said Data Management Policy, select the (k)th media type for said new data storage medium, wherein said (k)th media type is one of said (M) media types;

21. The computer program product of claim 19, wherein said new data storage medium comprises a VOLSER, further comprising:
computer readable program code which causes said programmable computer processor to, based upon said Data Management Policy, determine if the (i)th data storage medium will be retained;
computer readable program code which, if the (i)th data storage medium will not be retained causes said programmable computer processor to:
destroy said (i)th data storage medium after performed said copying step;
associate said VOLSER with the (i)th data storage medium.

22. The computer program product of claim 21, further comprising:
computer readable program code which, if the (i)th data storage medium will be retained causes said programmable computer processor to:
set (N) equal to (N+1); and
associate said VOLSER with the (N+1)th data storage medium.

23. The computer program product of claim 19, further comprising:
computer readable program code which, if the (i)th medium quality is greater than the (j)th Media Quality Threshold causes said programmable computer processor to:
determining the (i)th environmental parameters;
retrieving the (j)th Environmental Threshold;
determining if said (i)th environmental parameters are greater than the (j)th Environmental Threshold;
computer readable program code which, if said (i)th environmental parameters are greater than the (j)th Environmental Threshold, causes said programmable computer processor to copy the information encoded on said (i)th data storage medium to a new data storage medium.

24. The computer program product of claim 23, further comprising:
computer readable program code which, if the (i)th environmental parameters are not greater than the (j)th Environmental Threshold causes said programmable computer processor to:
determine the (i)th access parameters;
retrieve the (j)th Access Threshold;
determine if said (i)th access parameters are greater than the (j)th Access Threshold;
computer readable program code which, if said (i)th access parameters are greater than the (j)th Access Threshold causes said programmable computer processor to copy the information encoded on said (i)th data storage medium to a new data storage medium.

25. The computer program product of claim 24, further comprising:
computer readable program code which, if the (i)th access parameters are not greater than the (j)th Access Threshold, causes said programmable computer processor to:
determine the (i)th age parameters;
retrieve the (j)th Age Threshold;
determine if said (i)th age parameters are greater than the (j)th Age Threshold;
computer readable program code which, if said (i)th age parameters are greater than the (j)th Age Threshold, causes said programmable computer processor to copy the information encoded on said (i)th data storage medium to a new data storage medium.

26. The computer program product of claim 25, further comprising:
computer readable program code which, if the (i)th age parameters are not greater than the (j)th Age Threshold: causes said programmable computer processor to:
determine if said Data Management Policy requires that the (i)th data storage medium be refreshed;
computer readable program code which, if said Data Management Policy requires that the (i)th data storage medium be refreshed, causes said programmable computer processor to:
load the (i)th data storage medium in a data storage device capable of reading data encoded on said (i)th data storage medium and encoding data on said (i)th data storage medium;
read the information encoded on said (i)th data storage medium, wherein said information is encoded on said (i)th data storage medium in a first format;
determine if said Data Management Policy requires a format conversion;
computer readable program code which, if said Data Management Policy does not requires a format conversion, causes said programmable computer processor to write said information in said first format to said (i)th data storage medium;
computer readable program code which, if said Data Management Policy does requires a format conversion, causes said programmable computer processor to:
convert said information from said first format to a second format;
write said information in said second format to said (i)th data storage medium.

27. A method to provide data storage services, comprising the steps of:
providing (N) data storage media comprising information, wherein each of said (N) data storage media comprises one of (M) media types, wherein (N) is greater than or equal to 1, and wherein (M) is greater than or equal to 1;
receiving information from a data storage services customer;
encoding said information on said (N) data storage media;
receiving from said customer a Media Quality Threshold for each of said (M) media types;
receiving from said customer an Access Threshold for each of said (M) media types;
receiving from said customer an Age Threshold for each of said (M) media types;
receiving from said customer an Environmental Threshold for each of said (M) media types;
receiving from said customer a Data Management Policy for each of said (M) media types;
selecting, based upon said customer Data Management Policy, the (i)th data storage medium, wherein said (i)th data storage medium is one of said (N) data storage media, and wherein said (i)th data storage medium comprises the (j)th media type, wherein the (j)th media type is one of said (M) media types;
determining the (i)th medium quality;
ascertaining if the (i)th medium quality is greater than the (j)th Media Quality Threshold;
operative if the (i)th medium quality is not greater than the (j)th Media Quality Threshold:
supplying a new data storage medium, wherein said new data storage medium is not one of said (N) data storage media; and
copying the information encoded on said (i)th data storage medium to said new data storage medium.

28. The method of claim 27, further comprising the steps of:
operative if the (i)th medium quality is greater than the (j)th Media Quality Threshold:
determining the (i)th environmental parameters;
retrieving the (j)th Environmental Threshold;
determining if said (i)th environmental parameters are greater than the (j)th Environmental Threshold;
operative if said (i)th environmental parameters are greater than the (j)th Environmental Threshold:
supplying a new data storage medium, wherein said new data storage medium is not one of said (N) data storage media; and
copying the information encoded on said (i)th data storage medium to said new data storage medium.

29. The method of claim 28, further comprising the steps of:
operative if the (i)th environmental parameters are greater than the (j)th Environmental Threshold:
determining the (i)th access parameters;
retrieving the (j)th Access Threshold;
determining if said (i)th access parameters are greater than the (j)th Access Threshold;
operative if said (i)th access parameters are greater than the (j)th Access Threshold:
supplying a new data storage medium, wherein said new data storage medium is not one of said (N) data storage media; and
copying the information encoded on said (i)th data storage medium to said new data storage medium.

30. The method of claim 29, further comprising the steps of:
operative if the (i)th access parameters are greater than the (j)th Access Threshold:
determining the (i)th age parameters;
retrieving the (j)th Age Threshold;
determining if said (i)th age parameters are greater than the (j)th Age Threshold;
operative if said (i)th age parameters are greater than the (j)th Age Threshold:
supplying a new data storage medium, wherein said new data storage medium is not one of said (N) data storage media; and
copying the information encoded on said (i)th data storage medium to said new data storage medium.

31. The method of claim 30, further comprising the steps of:
operative if the (i)th age parameters are not greater than the (j)th Age Threshold:
determining if said Data Management Policy requires that the (i)th data storage medium be refreshed;
operative if said Data Management Policy requires that the (i)th data storage medium be refreshed:
loading the (i)th data storage medium in a data storage device capable of reading data encoded on said (i)th data storage medium and encoding data on said (i)th data storage medium;
reading said information encoded on said (i)th data storage medium, wherein said information is encoded on said (i)th data storage medium in a first format;
determining if said Data Management Policy requires a format conversion;
operative if said Data Management Policy does not requires a format conversion, writing said information in said first format to said (i)th data storage medium;
operative if said Data Management Policy does requires a format conversion:
converting said information from said first format to a second format;
writing said information in said second format to said (i)th data storage medium.
